(19) United States
(12) Patent Application Publication
(10) Pub. No.: US 2026/0139103 A1
(43) Pub. Date: May 21, 2026

(54) ANTI-FINGERPRINT AGENT AND PREPARATION METHOD THEREOF

(71) Applicants: HUNAN TIFUL NEW MATERIAL CO., LTD., Changsha (CN); SHENZHEN ECHENG NEW MATERIALS CO., LTD., Shenzhen (CN)

(72) Inventors: Qibao DONG, Changsha (CN); Chaoxiang WANG, Changsha (CN); Mingrui GAO, Changsha (CN); Yusi ZHOU, Changsha (CN); Xia KANG, Changsha (CN); Zhengjie PENG, Changsha (CN); Zuxia CHE, Changsha (CN)

(73) Assignees: HUNAN TIFUL NEW MATERIAL CO., LTD., Changsha (CN); SHENZHEN ECHENG NEW MATERIALS CO., LTD., Shenzhen (CN)

(21) Appl. No.: 19/319,786

(22) Filed: Sep. 5, 2025

Related U.S. Application Data
(63) Continuation of application No. PCT/CN2025/088564, filed on Apr. 11, 2025.

(30) Foreign Application Priority Data
Nov. 18, 2024 (CN) 202411640685.6

(51) Int. Cl. C08G 83/00; B01J 27/122; B01J 27/128

(52) U.S. Cl. CPC C08G 83/005; B01J 27/122; B01J 27/128

(57) ABSTRACT

An anti-fingerprint agent and a preparation method thereof are provided. The anti-fingerprint agent is constructed from compounds such as trichlorotriazine, fluorinated aromatic diamine, methyl acrylate, chloroalkyl siloxane through substitution reactions, addition reactions, polymerization reactions, etc. The anti-fingerprint agent has a hyperbranched three-dimensional structure and contains C—F bonds and silane-terminated groups. After coating, an initial water contact angle on the substrate surface is over 111°. Even after 5,000 cycles of rubbing with a rubber and a steel wool, the water contact angle remains around 105°.

### CROSS-REFERENCE TO RELATED APPLICATIONS

This application is a Continuation of International Application No. PCT/CN2025/088564, filed on Apr. 11, 2025, which claims priority to Chinese Patent Application No. 202411640685.6, filed on Nov. 18, 2024, the entire contents of each of which are hereby incorporated by reference.

### TECHNICAL FIELD

The present disclosure relates to the technical field of new materials, in particular to an anti-fingerprint agent with a hyperbranched three-dimensional structure, containing C—F bonds and silane-terminated groups, and also to a preparation method for the anti-fingerprint agent.

### BACKGROUND

In recent years, high-tech products such as mobile phones, laptops, digital bracelets, and wearable electronic products have been favored by consumers, but during frequent use, shells and screen surfaces of these electronic products are very susceptible to fingerprints, oils on the skin, sweat and cosmetics, resulting in blurring of the windows and reducing image quality and aesthetic appearance. Therefore, high requirements are imposed on the anti-fingerprint performance of coatings applied to the shells and screen surface of the electronic products.

Fluorocarbons have excellent heat resistance and chemical stability, water and oil repellency, and low surface energy, which are often used for hydrophobic and oleophobic modification of various materials. Therefore, the fluorocarbons/polymers have generally become a main component of anti-fingerprint coatings. For example, Chinese Patent Application (Publication No. CN104559761A) discloses that a silane coupling agent, water, a co-solvent, and heptadecafluorodecyltriethoxysilane react at 60-80° C. for 2-4 h to obtain an anti-fingerprint coating, the anti-fingerprint coating is coated on a substrate and baked at 180-220° C. for 3-7 min to obtain the fluorine-containing anti-fingerprint coating. The coating has good anti-fingerprint property and good adhesion to the substrate. Chinese Patent Application (Publication No. CN113265199 A) adopts perfluorononane, perfluorooctyltriethoxysilane, dodecafluoroheptyl methacrylate, polyvinylidene fluoride, methyl methacrylate, and cosolvent to prepare hydrophobic and light-release fluorine material coatings, which is characterized by aging-resistance, good hydrophobicity, resistance to oil contamination, and light-release, at the same time, a hardness of the coating reaches 2H. However, a use of perfluorinated long-chain alkanes (PFLAs) inevitably poses risks to human health and the environment. In addition, with a proposal of the European Union to restrict perfluoroalkyl or polyfluoroalkyl substances (PFASs), a use of long-chain perfluoro and polyfluoroalkane compounds is limited. Therefore, it is urgent to develop an environmentally friendly anti-fingerprint agent with relatively low fluorine content.

### SUMMARY

One or more embodiments of the present disclosure provide an anti-fingerprint agent having a structural formula as follows:

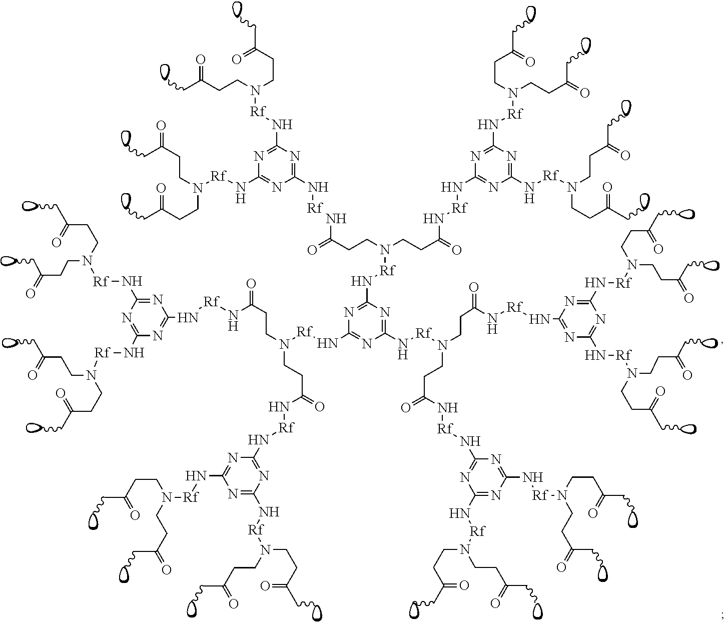

Rf is a fluoroaromatic moiety,
[symbol] is a structural unit as follows

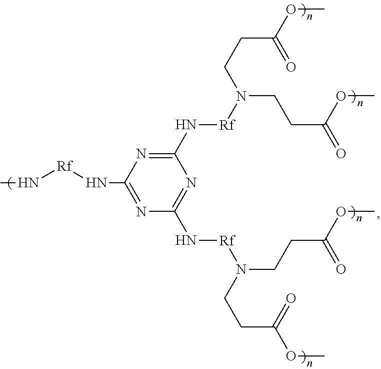

n is an integer between 1 and 3000; and [symbol]
is a fluorosiloxane moiety.

One or more embodiments of the present disclosure also provides a method for preparing the anti-fingerprint agent, including:
a) 2,4,6-trichloro-1,3,5-triazine and fluorinated aromatic diamine undergoing a substitution reaction I to obtain 2,4,6-tris(fluorinated aromatic diamine)-1,3,5-triazine; and
2,4,6-trichloro-1,3,5-triazine and fluorinated aromatic diamine undergoing a substitution reaction II to obtain 2-chloro-4,6-bis(fluorinated aromatic diamine)-1,3,5-triazine;
the 2,4,6-tris(fluorinated aromatic diamine)-1,3,5-triazine having a structural formula as follows:

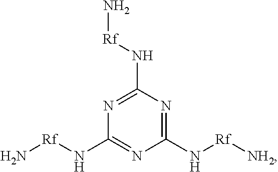

the 2-chloro-4,6-bis(fluorinated aromatic diamine)-1,3,5-triazine having a structural formula as follows:

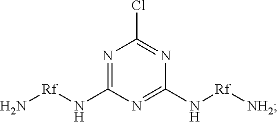

b) the 2,4,6-tris(fluorinated aromatic diamine)-1,3,5-triazine and methyl acrylate undergoing an addition reaction I to obtain intermediate I;
the intermediate I having a structural formula as follows:

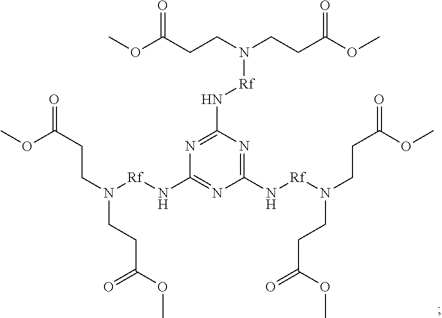

c) the 2-chloro-4,6-bis(fluorinated aromatic diamine)-1,3,5-triazine and methyl acrylate undergoing an addition reaction II to obtain intermediate II;
the intermediate II having a structural formula as follows:

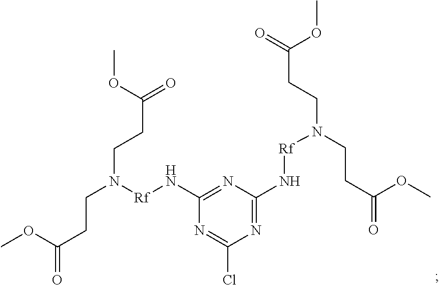

d) the intermediate II and the fluorinated aromatic diamine undergoing a substitution reaction III to obtain monomer I;
the monomer I having a structural formula as follows:

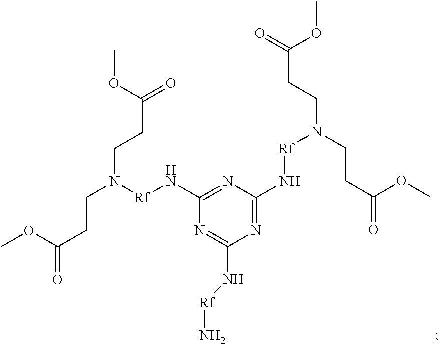

e) the intermediate I and the monomer I undergoing a polymerization reaction to obtain the hyperbranched fluorinated polyurethane;
the hyperbranched fluorinated polyurethane having a structural formula as follows:

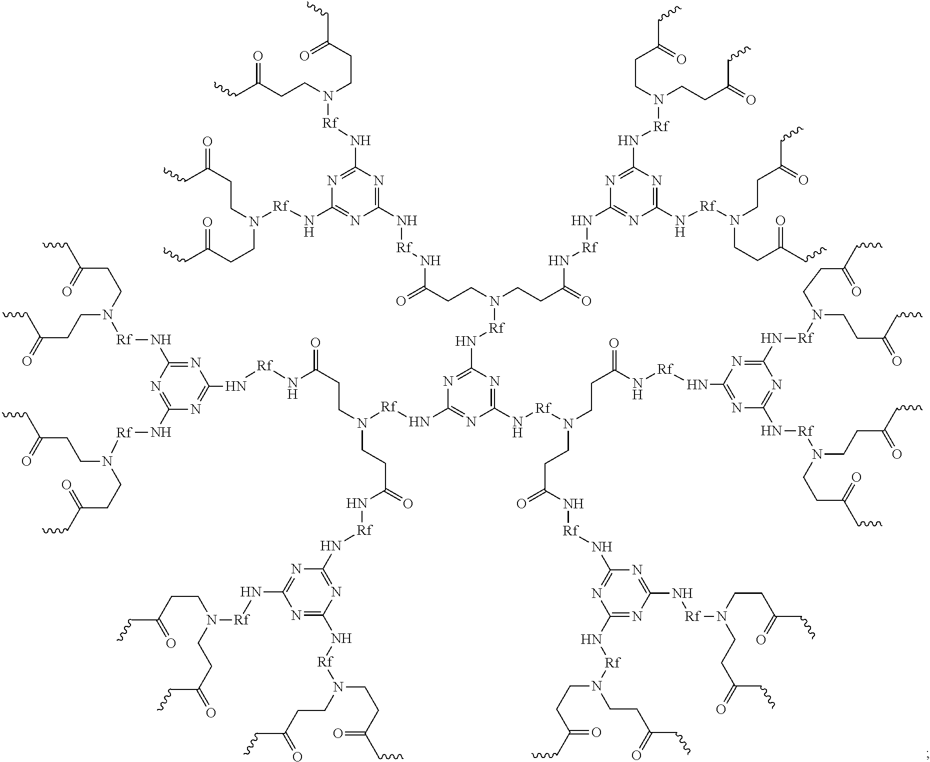

f) chloroalkyl siloxane and fluorinated aromatic diamine undergoing a substitution reaction IV to obtain siloxane-containing fluorinated aromatic diamine;
the siloxane-containing fluorinated aromatic diamine having a structural formula as follows:

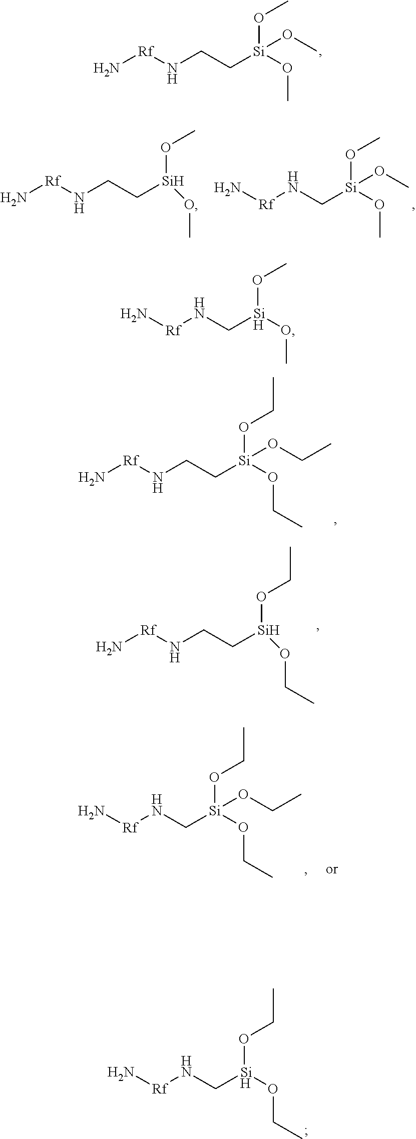

and
g) the hyperbranched fluorinated polyurethane and the siloxane-containing fluorinated aromatic diamine undergoing a substitution reaction V to obtain the anti-fingerprint agent.

### BRIEF DESCRIPTION OF THE DRAWINGS

FIG. 1 is a proton nuclear magnetic resonance (¹H NMR) spectrum of the anti-fingerprint agent with a three-dimensional structure prepared in Example 1.

### DETAILED DESCRIPTION

To make the objects, technical solutions, and advantages of the embodiments of the present disclosure clearer, the technical solutions in the embodiments will be described clearly and completely below in conjunction with the embodiments of the present disclosure. It is apparent that the described embodiments are part of the present disclosure, rather than all embodiments. All other embodiments obtained by those skilled in the art based on the embodiments of the present disclosure without inventive efforts shall fall within the scope of the present disclosure.

One or more embodiments of the present disclosure provide an anti-fingerprint agent having a structural formula as follows:

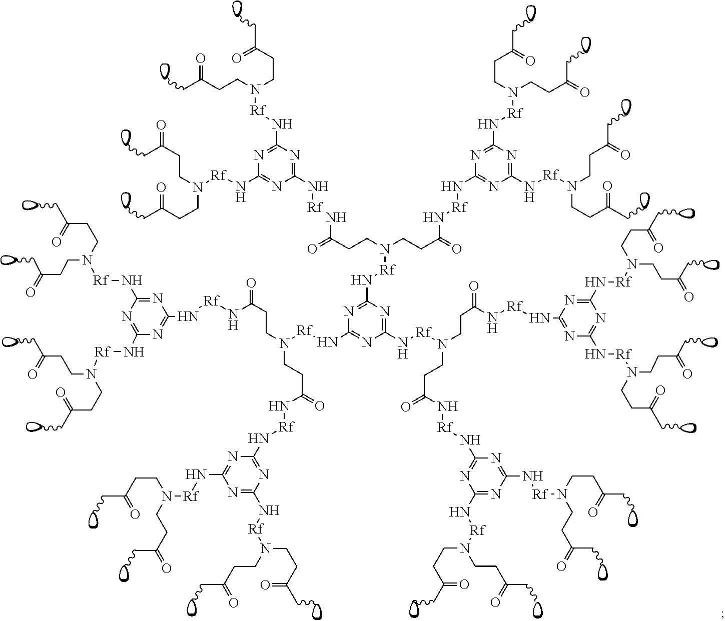

wherein Rf is a fluoroaromatic moiety,
[symbol] is a structural unit as follows:

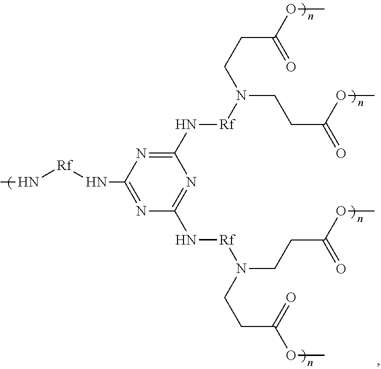

n is an integer between 1 and 3000; and
[symbol] is a fluorosiloxane moiety.

The anti-fingerprint agent provided by the present disclosure has a special molecular structure. On the one hand, the anti-fingerprint agent has the hyperbranched three-dimensional structure, which significantly improves tensile resistance and abrasion resistance properties of a polyurethane matrix polymer. On the other hand, an appropriate amount of the C—F bonds is introduced into a hyperbranched main chain through an aryl unit, and siloxane is introduced as an end-capping group. An introduction of fluorine and silicon improves the polarity, stability, and heat resistance of a polyurethane matrix, and imparts excellent hydrophobic, anti-fouling, anti-fingerprint, abrasion resistance, and other properties to the anti-fingerprint agent. Moreover, the anti-fingerprint agent does not contain perfluoroalkyl or polyfluoroalkyl substances (PFASs) restricted by the European Union, making the anti-fingerprint agent environmentally friendly.

In some embodiments, the fluoroaromatic moiety has a structural formula as follows:

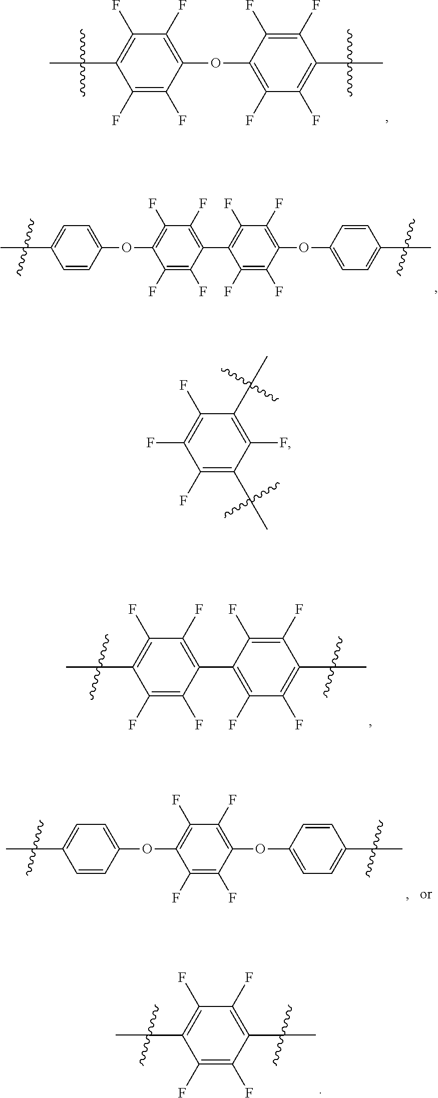 [SMILES: *c1c(F)c(F)c(Oc2c(F)c(F)c(*)c(F)c2F)c(F)c1F ; *c1ccc(Oc2c(F)c(F)c(-c3c(F)c(F)c(Oc4ccc(*)cc4)c(F)c3F)c(F)c2F)cc1 ; *c1c(F)c(*)c(F)c(F)c1F ; *c1c(F)c(F)c(-c2c(F)c(F)c(*)c(F)c2F)c(F)c1F ; *c1ccc(Oc2c(F)c(F)c(Oc3ccc(*)cc3)c(F)c2F)cc1 ; *c1c(F)c(F)c(*)c(F)c1F]

The fluoroaromatic moiety is used to replace conventional perfluoroalkyl or polyfluoroalkyl substances, which can obtain the anti-fingerprint agents with low toxicity, degradability, with environmental friendliness.

In some embodiments, the fluorosiloxane moiety has a structural formula as follows:

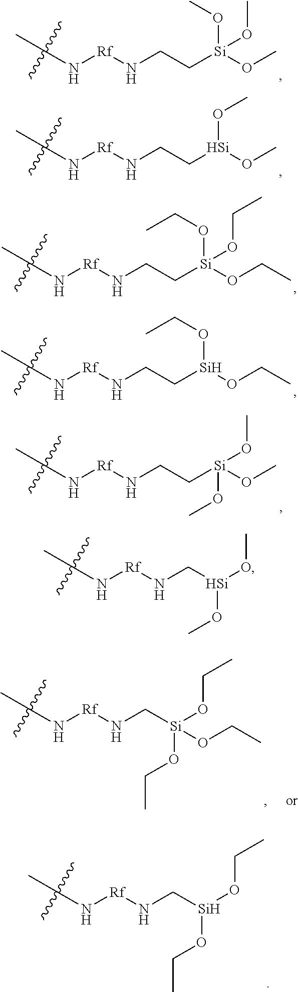

A siloxane group is used for end-capping a hyperbranched fluorinated polyurethane, thereby imparting strong polarity, high stability, and excellent thermal resistance to a hyperbranched polymer.

One or more embodiments of the present disclosure provide a method for preparing the anti-fingerprint agent. The method includes following steps.
a) 2,4,6-trichloro-1,3,5-triazine and fluorinated aromatic diamine undergoing a substitution reaction I to obtain 2,4,6-tris(fluorinated aromatic diamine)-1,3,5-triazine; and 2,4,6-trichloro-1,3,5-triazine and fluorinated aromatic diamine undergoing a substitution reaction II to obtain 2-chloro-4,6-bis(fluorinated aromatic diamine)-1,3,5-triazine;
wherein the 2,4,6-tris(fluorinated aromatic diamine)-1,3,5-triazine has a structural formula as follows:

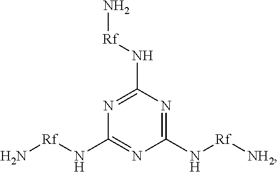

the 2-chloro-4,6-bis(fluorinated aromatic diamine)-1,3,5-triazine has a structural formula as follows:

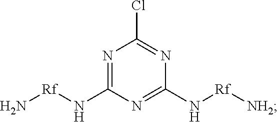

b) the 2,4,6-tris(fluorinated aromatic diamine)-1,3,5-triazine and methyl acrylate undergoing an addition reaction I to obtain intermediate I;
wherein the intermediate I has a structural formula as follows:

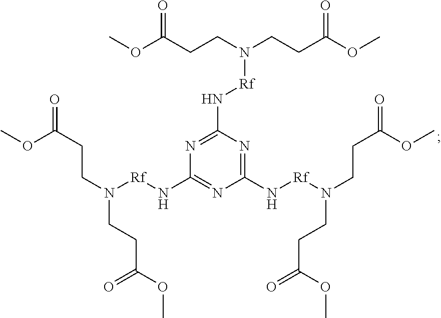

c) the 2-chloro-4,6-bis(fluorinated aromatic diamine)-1,3,5-triazine and methyl acrylate undergoing an addition reaction II to obtain intermediate II;
wherein the intermediate II has a structural formula as follows:

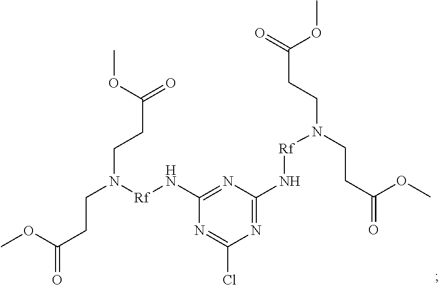

d) the intermediate II and fluorinated aromatic diamine undergoing a substitution reaction III to obtain monomer I;
wherein the monomer I has a structural formula as follows:

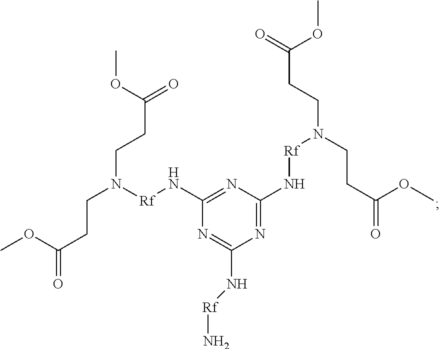

e) the intermediate I and the monomer I undergoing a polymerization reaction to obtain a hyperbranched fluorinated polyurethane;
wherein the hyperbranched fluorinated polyurethane has a structural formula as follows:

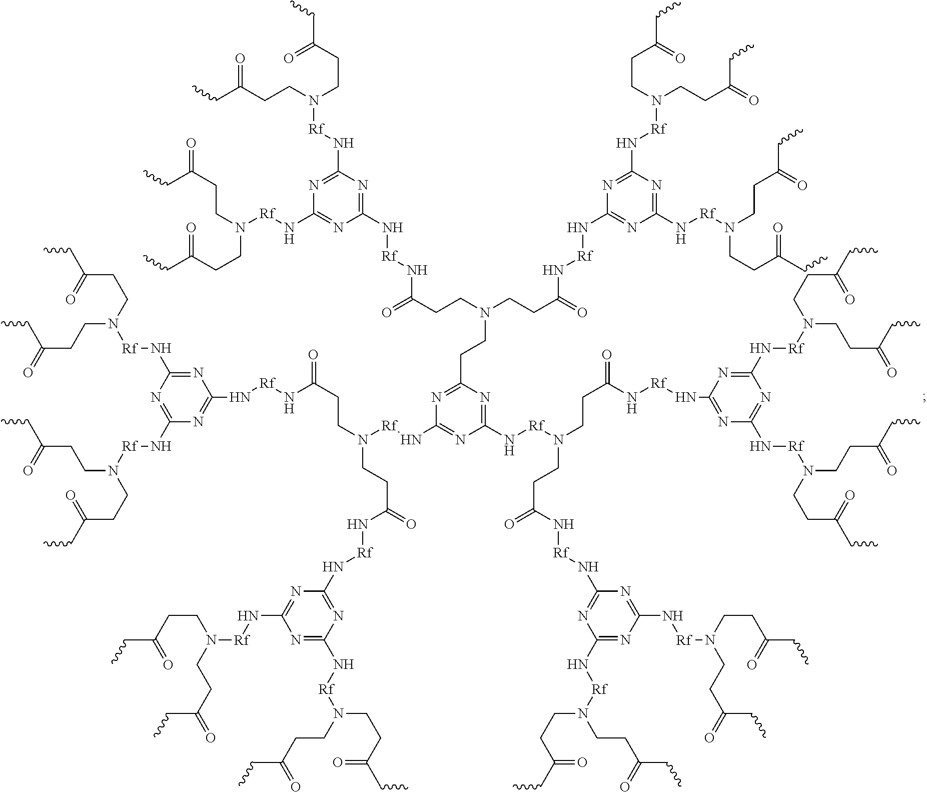

f) chloroalkyl siloxane and fluorinated aromatic diamine undergoing a substitution reaction IV to obtain siloxane-containing fluorinated aromatic diamine;
wherein the siloxane-containing fluorinated aromatic diamine has a structural formula as follows:

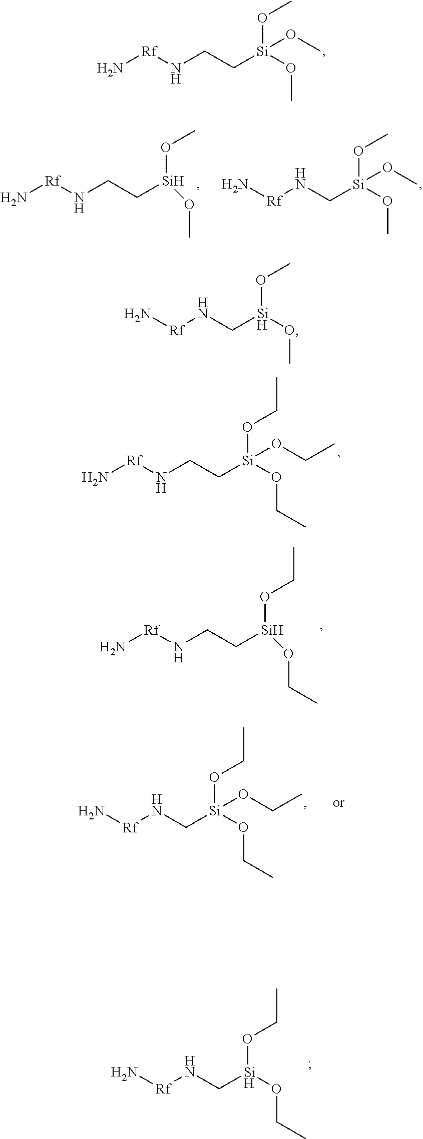

and
g) the hyperbranched fluorinated polyurethane and the siloxane-containing fluorinated aromatic diamine undergoing a substitution reaction V to obtain the anti-fingerprint agent.

In some embodiments, the fluorinated aromatic diamine includes at least one of:

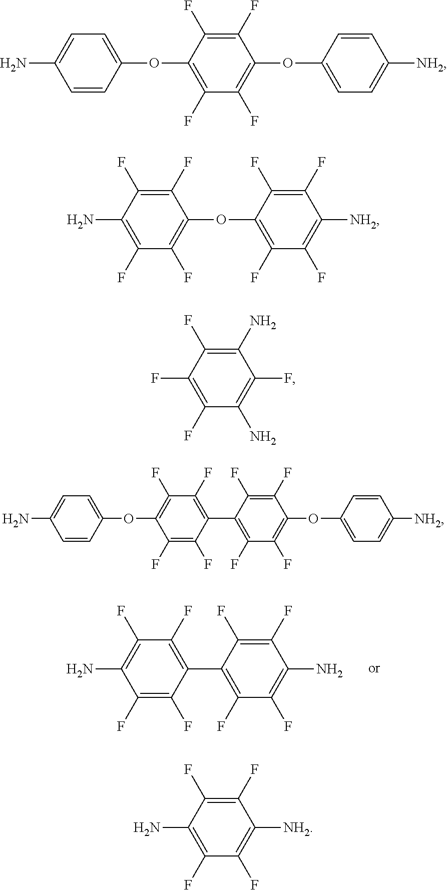

In some embodiments, the chloroalkyl siloxane includes at least one of:

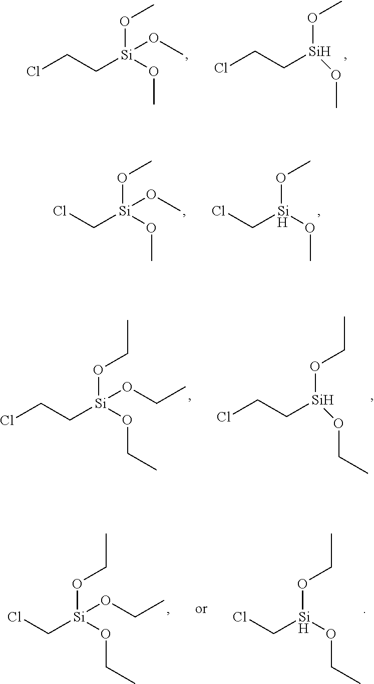

In some embodiments, a reaction condition of the substitution reaction I, the substitution reaction II, and the substitution reaction III is reacting for 2-6 h in an ice-water bath in the presence of a base. A molar ratio of the 2,4,6-trichloro-1,3,5-triazine to the fluorinated aromatic diamine in the substitution reaction I is 1:(3-3.8). A molar ratio of the 2,4,6-trichloro-1,3,5-triazine to the fluorinated aromatic diamine in the substitution reaction II is 1:(1.8-2.4). A molar ratio of the intermediate II to the fluorinated aromatic diamine in the substitution reaction III is 1:(0.7-1.2). In some embodiments, a base in the substitution reaction I, the substitution reaction II, and the substitution reaction III may include sodium carbonate, potassium carbonate, sodium bicarbonate, potassium bicarbonate, triethylamine, etc. In some embodiments, a solvent in the substitution reaction I, the substitution reaction II, and the substitution reaction III may include acetone, chloroform, carbon tetrachloride, etc.

In some embodiments, a reaction condition of the substitution reaction IV is reacting for 2-4 h at room temperature. A molar ratio of the chloroalkyl siloxane to the fluorinated aromatic diamine in the substitution reaction IV is 1:(1-1.6). In some embodiments, a solvent in the substitution reaction IV may include dichloromethane, dichloroethane, trichloropropane, chloroform, etc.

In some embodiments, a reaction condition of the substitution reaction V is reacting for 4-8 h at room temperature under a catalytic action of catalysts such as ferric chloride, aluminum chloride, and copper chloride. A molar ratio of the hyperbranched fluorinated polyurethane to the siloxane-containing fluorinated aromatic diamine in the substitution reaction V is 1:(4-5)*(6+24n), n being an integer between 0 and 3000. In some embodiments, a solvent in the substitution reaction V may include dichloromethane, dichloroethane, trichloropropane, chloroform, etc.

In some embodiments, a reaction condition of an addition reaction I and the addition reaction II is refluxing for 4-10 h at 80-120° C. under a catalytic action of copper chloride. A molar ratio of the 2,4,6-tris(fluorinated aromatic diamine)-1,3,5-triazine to the methyl acrylate in the addition reaction I is 1:(6-8). A molar ratio of the 2-chloro-4,6-bis(fluorinated aromatic diamine)-1,3,5-triazine to the methyl acrylate in the addition reaction II is 1:(4-5). In some embodiments, the addition reaction I or the addition reaction II may include acetic acid, propionic acid, n-butanoic acid, etc.

In some embodiments, a reaction condition of the polymerization reaction is refluxing for 8-12 h at 80-120° C. in the presence of a base. A molar ratio of the intermediate I to the monomer I in the polymerization reaction is 1:(1-1.2)*(6+24n), n being an integer between 0 and 3000. In some embodiments, a base in the polymerization reaction may include sodium hydroxide, potassium hydroxide, sodium carbonate, potassium carbonate, calcium oxide, and magnesium oxide. In some embodiments, a solvent in the polymerization reaction may include dichloromethane, dichloroethane, trichloropropane, and chloroform.

In some embodiments, the anti-fingerprint agent is used to form an anti-fingerprint coating.

In some embodiments, the anti-fingerprint agent is coated on a substrate by vacuum evaporation. An initial water contact angle on the substrate surface is above 111°, and even after 5000 cycles of rubbing with a rubber and a steel wool, the water contact angle still remains about 105°. An adhesion test result is 5B. A substrate coated with the anti-fingerprint agent exhibits excellent anti-fingerprint property and abrasion durability.

In some embodiments, the method for preparing the anti-fingerprint agent includes following steps.
a) 2,4,6-trichloro-1,3,5-triazine, fluorinated aromatic diamine, acetone, and sodium carbonate (based on a weight percentage (wt %) of 2,4,6-trichloro-1,3,5-triazine) are weighed and added to a reactor, and the mixture reacts in an ice-water bath for 2-6 h. By adjusting the molar ratio of 2,4,6-trichloro-1,3,5-triazine to the fluorinated aromatic diamine, the substitution reactions I and the substitution reactions II occur, respectively. The resulting products are separated and purified by a column chromatography (hexane:ethyl acetate=60:40, v/v) to obtain 2,4,6-tris(fluorinated aromatic diamine)-1,3,5-triazine and 2-chloro-4,6-bis(fluorinated aromatic diamine)-1,3,5-triazine. The structural formulas of the 2,4,6-tris(fluorinated aromatic diamine)-1,3,5-triazine and the 2-chloro-4,6-bis(fluorinated aromatic diamine)-1,3,5-triazine are shown below:

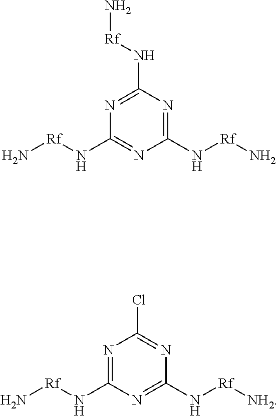

The fluorinated aromatic diamine is an aromatic diamine containing fluorine substituents or an aromatic diamine containing short-chain fluoroalkyl groups. For example, the fluorinated aromatic diamine may be at least one of the following compounds:

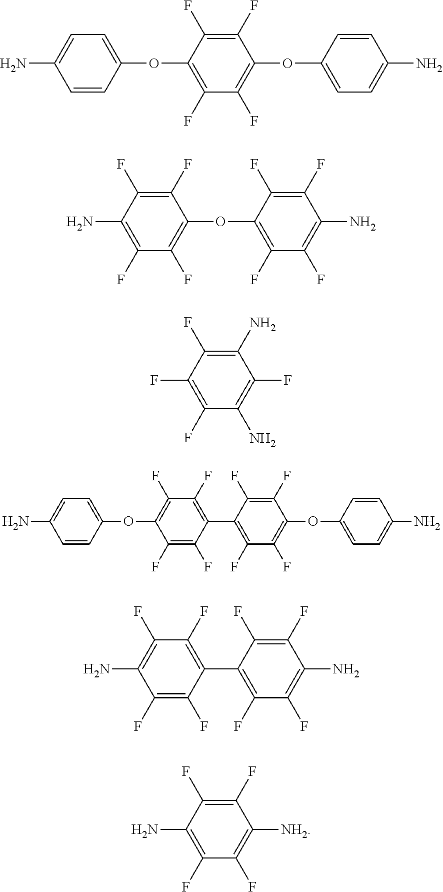

In some embodiments, the fluorinated aromatic diamine is 4,4′-diaminooctafluorobiphenyl.

By selecting an appropriate molar ratio of 2,4,6-trichloro-1,3,5-triazine to the fluorinated aromatic diamine, it is possible to obtain 2,4,6-tris(fluorinated aromatic diamine)-1,3,5-triazine or 2-chloro-4,6-bis(fluorinated aromatic diamine)-1,3,5-triazine. In some embodiments, in the substitution reaction I, the molar ratio of 2,4,6-trichloro-1,3,5-triazine to the fluorinated aromatic diamine is 1:(3-3.8). In some embodiments, the molar ratio of 2,4,6-trichloro-1,3,5-triazine to the fluorinated aromatic diamine is 1:3.4. In this case, the obtained product is 2,4,6-tris(fluorinated aromatic diamine)-1,3,5-triazine. In some embodiments, in the substitution reaction II, the molar ratio of 2,4,6-trichloro-1,3,5-triazine to the fluorinated aromatic diamine is 1:(1.8-2.4). In some embodiments, the molar ratio of 2,4,6-trichloro-1,3,5-triazine to the fluorinated aromatic diamine is 1:2.1. In this case, the obtained product is 2-chloro-4,6-bis(fluorinated aromatic diamine)-1,3,5-triazine.
b) 2,4,6-tris(fluorinated aromatic diamine)-1,3,5-triazine, methyl acrylate, acetic acid, and copper chloride (wt % based on methyl acrylate) are weighed and added to a reactor. Under a nitrogen atmosphere, the mixture is refluxed at 80-120° C. for 4-10 h to carry out the addition reaction I. After washing and vacuum distillation, the product is purified by a silica chromatography column (methanol:ethyl acetate:triethylamine=10:90:5, v/v/v) to obtain the intermediate I. The structural formula of the intermediate I is shown below:

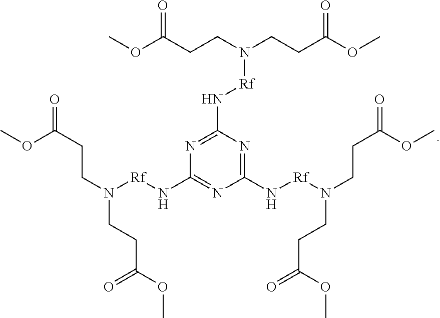

In the addition reaction I, the molar ratio of 2,4,6-tris(fluorinated aromatic diamine)-1,3,5-triazine to methyl acrylate is 1:(6-8). In some embodiments, the molar ratio of 2,4,6-tris(fluorinated aromatic diamine)-1,3,5-triazine to methyl acrylate is 1:7.2.
c) 2-chloro-4,6-bis(fluorinated aromatic diamine)-1,3,5-triazine, methyl acrylate, acetic acid, and copper chloride (wt % based on methyl acrylate) are weighed and added to a reactor. Under the nitrogen atmosphere, the mixture is refluxed at 80-120° C. for 4-10 h to carry out the addition reaction II. After washing and vacuum distillation, the product is purified by the silica chromatography column (petroleum ether:ethyl acetate:triethylamine=50:50:3, v/v/v) to obtain the intermediate II. The structural formula of the intermediate II is shown below:

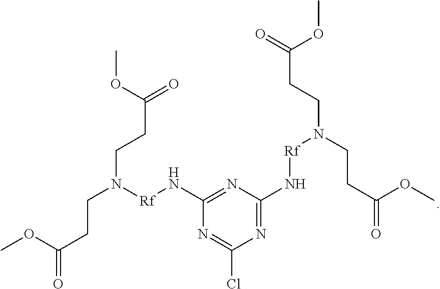

In the addition reaction II, the molar ratio of the 2-chloro-4,6-bis(fluorinated aromatic diamine)-1,3,5-triazine to methyl acrylate is 1:(4-5). In some embodiments, a molar ratio of 2-chloro-4,6-bis(fluorinated aromatic diamine)-1,3,5-triazine to methyl acrylate is 1:4.1.
d) The intermediate II, fluorinated aromatic diamine, acetone, and sodium carbonate (wt % based on fluorinated aromatic diamine) are weighed and added to a reactor. The mixture reacts in the ice-water bath for 2-6 h to carry out the substitution reaction III. After washing and vacuum distillation, the monomer I is obtained. The structural formula of the monomer I is shown below:

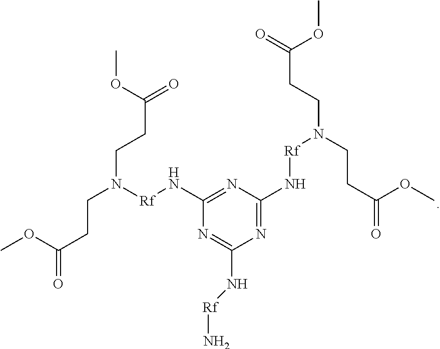

In the substitution reaction III, the molar ratio of the intermediate II to fluorinated aromatic diamine is 1:(0.7-1.2). In some embodiments, the molar ratio of the intermediate II and fluorinated aromatic diamine is 1:1.1.
e) The intermediate I, the monomer I, the acetone, and sodium hydroxide (wt % based on monomer I) are weighed and added to a reactor. Under refluxing at 80-120° C., excess monomer I and the intermediate I undergo a polymerization reaction to produce intermediate III, which is a hyperbranched fluorinated polyurethane with a three-dimensional structure. The structural formula of the intermediate III is shown below:

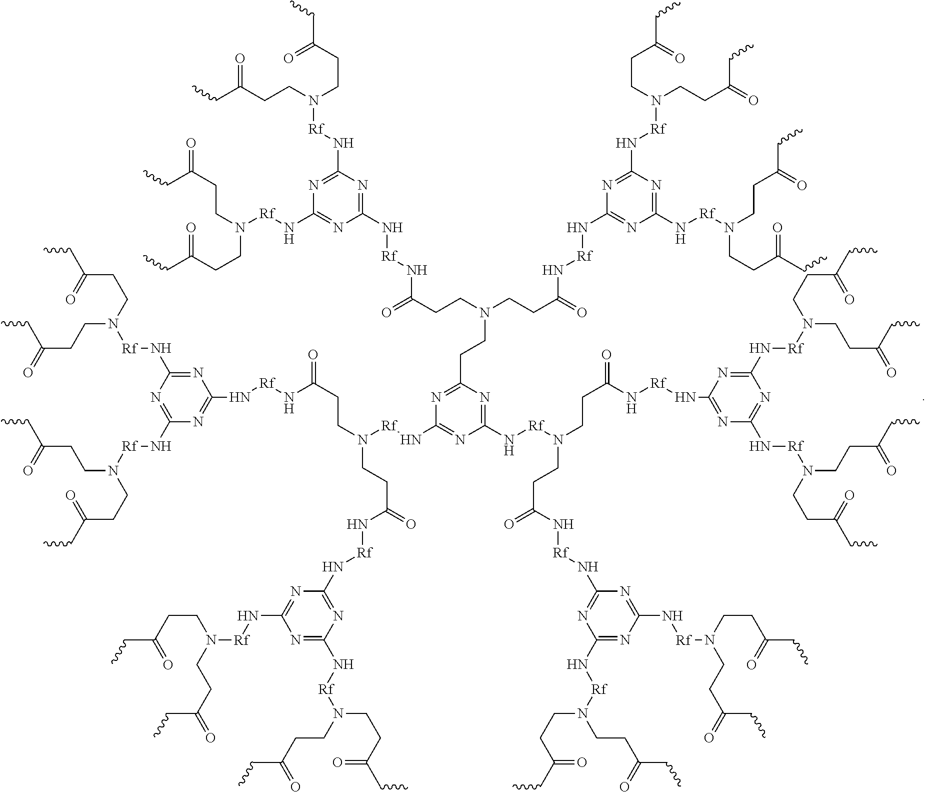

In the polymerization reaction, the molar ratio of the intermediate I to the monomer I is 1:(1-1.2)*(6+24n), n being an integer between 0 and 3000. In some embodiments, the molar ratio of the intermediate I to the monomer I is 1:1.1*(6+24n), n being an integer between 0 and 3000.
f) The chloroalkyl siloxane, the fluorinated aromatic diamine, and dichloromethane are weighed and added to a reactor. The mixture reacts at room temperature for 2-4 h to carry out a substitution reaction IV. After washing and distillation, a siloxane-containing fluorinated aromatic diamine is obtained. The structural formula of the siloxane-containing fluorinated aromatic diamine includes at least one of:

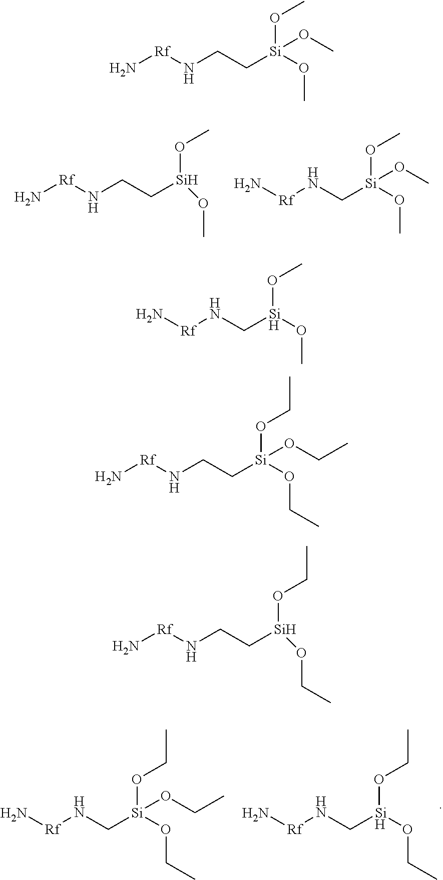

The chloroalkyl siloxane includes at least one of:

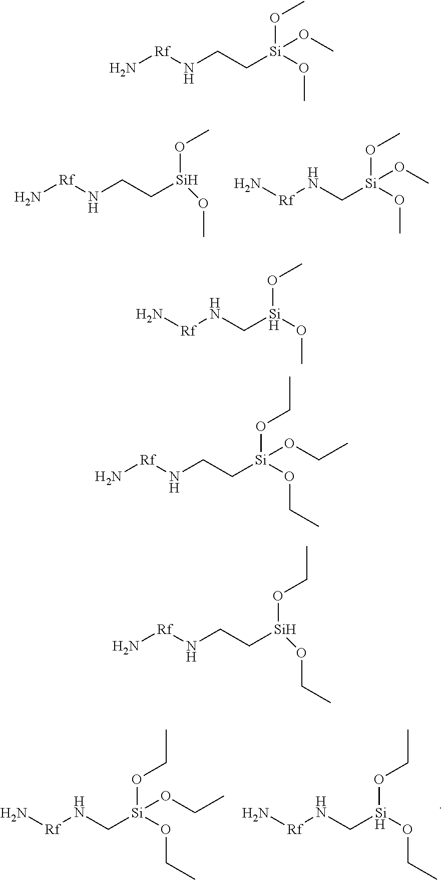

In some embodiments, the chloroalkyl siloxane is chloromethyltriethoxysilane. The molar ratio of chloroalkyl siloxane to fluorinated aromatic diamine in the substitution reaction IV is 1:(1-1.6). In some embodiments, the molar ratio of chloroalkyl siloxane to fluorinated aromatic diamine is 1:1.1.
g) The hyperbranched fluorinated polyurethane with the three-dimensional structure, the siloxane-containing fluorinated aromatic diamine, ferric chloride (wt % based on intermediate III), and dichloromethane are weighed and added to a reactor. The mixture reacts at room temperature for 4-8 h to carry out the substitution reaction V. After washing and distillation, a final product (i.e., an anti-fingerprint agent) is obtained. In the substitution reaction V, the molar ratio of the hyperbranched fluorinated polyurethane with the three-dimensional structure to the siloxane-containing fluorinated aromatic diamine is 1:(4-5)*(6+24n), where n is an integer between 0 and 3000. In some embodiments, the molar ratio of the hyperbranched fluorinated polyurethane with the three-dimensional structure to the siloxane-containing fluorinated aromatic diamine is 1:4.6*(6+24n), where n is an integer between 0 and 3000.

### Example 1

An anti-fingerprint agent provided in this example has a structural formula as follows:

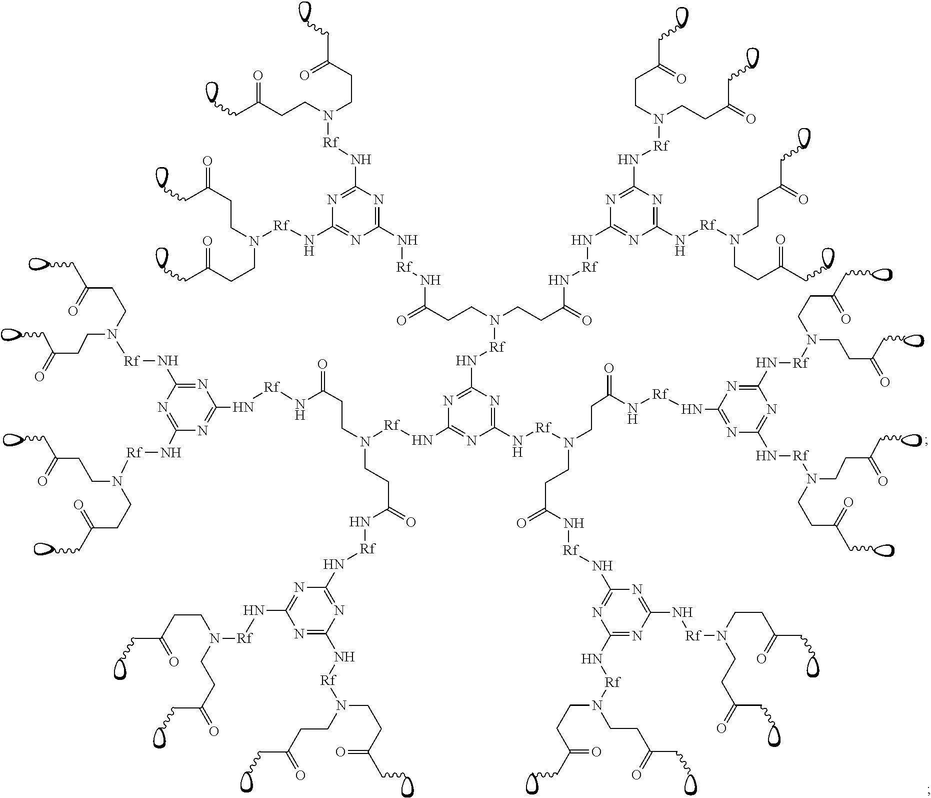

wherein Rf is a main structure of 4,4′-diaminooctafluorobiphenyl, whose structural formula is shown below:

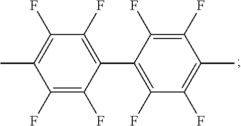

[symbol] is a polymer backbone structure of the 4,4′-diaminooctafluorobiphenyl, methyl acrylate, and trichlorotriazine, whose structural formula is shown below:

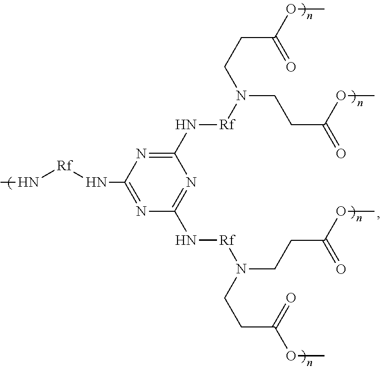

where n=10; and
[symbol] is a product of a substitution reaction between chloromethyltriethoxysilane and 4,4′-diaminooctafluorobiphenyl, whose structural formula is shown below:

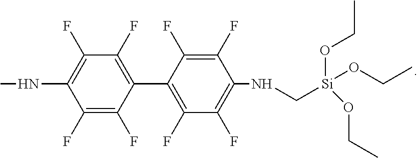 [SMILES: CCO[Si](CNc1c(F)c(F)c(-c2c(F)c(F)c(NC)c(F)c2F)c(F)c1F)(OCC)OCC]

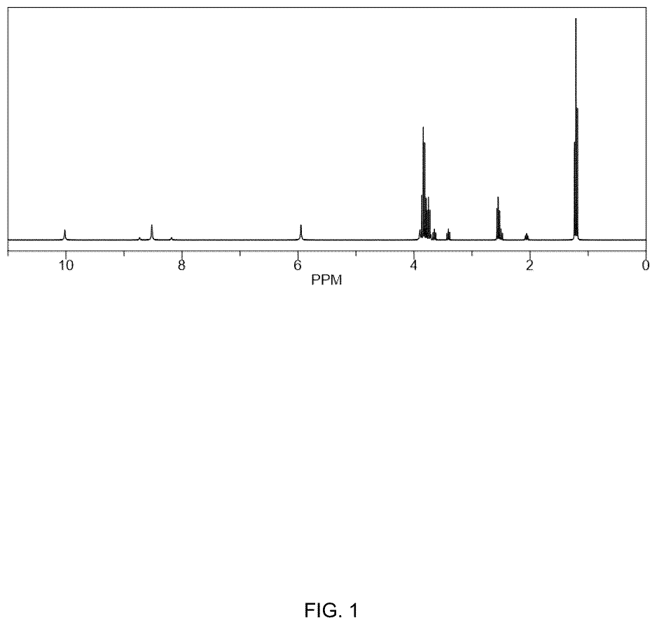

The preparation steps of the anti-fingerprint agent were as follows.
a) 2,4,6-trichloro-1,3,5-triazine (184.4 g, 1 mol) and 4,4′-diaminooctafluorobiphenyl were weighed at molar ratios of 1:3.4 and 1:2.1, respectively, and added together with acetone (5 mol) and sodium carbonate (2.5 wt % based on the 2,4,6-trichloro-1,3,5-triazine) into two separate reactors. A substitution reaction I and a substitution reaction II were carried out separately in an ice-water bath for 2 h. The products were separated and purified by column chromatography (hexane:ethyl acetate=60:40, v/v), to obtain 2,4,6-tris(fluorinated aromatic diamine)-1,3,5-triazine and 2-chloro-4,6-bis(fluorinated aromatic diamine)-1,3,5-triazine, respectively.
b) The 2,4,6-tris(fluorinated aromatic diamine)-1,3,5-triazine (1 mol) and methyl acrylate were weighed at a molar ratio of 1:7.2 and added together with acetic acid (5 mol) and copper chloride (2 wt % based on the methyl acrylate) into a reactor. Under a nitrogen atmosphere, the mixture was refluxed at 120° C. for 5 h to carry out an addition reaction I. After washing and vacuum distillation, the product was purified by a silica chromatography column (methanol:ethyl acetate:triethylamine=10:90:5, v/v/v) to obtain intermediate I.
c) The 2-chloro-4,6-bis(fluorinated aromatic diamine)-1,3,5-triazine (1 mol) and methyl acrylate were weighed at a molar ratio of 1:4.1 and added together with acetic acid (5 mol) and copper chloride (2 wt % based on the methyl acrylate) into a reactor. Under the nitrogen atmosphere, the mixture was refluxed at 120° C. for 5 h to carry out an addition reaction II. After washing and vacuum distillation, the product was purified by silica chromatography column (petroleum ether:ethyl acetate:triethylamine=50:50:3, v/v/v) to obtain intermediate II.
d) The intermediate II (1 mol) and the 4,4′-diaminooctafluorobiphenyl were weighed at a molar ratio of 1:1.1 and added together with acetone (5 mol) and sodium carbonate (2 wt % based on the 4,4′-diaminooctafluorobiphenyl) into a reactor. The mixture reacted in the ice-water bath for 3 h to carry out a substitution reaction III. After washing and vacuum distillation, monomer I was obtained.
e) The intermediate I (1 mol) and the monomer I were weighed at a molar ratio of 1:1.1*(6+24n) (n=10) and added together with acetone (5 mol) and sodium hydroxide (0.5 wt % based on the intermediate I) into a reactor. Under refluxing at 110° C. for 9 h, excess monomer I and the intermediate I undergone a polymerization reaction to produce intermediate III, which was a hyperbranched fluorinated polyurethane with a three-dimensional structure.
f) The chloromethyltriethoxysilane (1 mol) and the 4,4′-diaminooctafluorobiphenyl were weighed at a molar ratio of 1:1.1 and added together with dichloromethane (2 mol) into a reactor. The mixture reacted at room temperature for 2 h to carry out a substitution reaction IV. After washing and distillation, siloxane-containing fluorinated aromatic diamine was obtained.
g) The intermediate III (1 mol) and the siloxane-containing fluorinated aromatic diamine were weighed at a molar ratio of 1:4.6*(6+24n) (n=10) and added together with ferric chloride (3 wt % based on the intermediate III) and dichloromethane (10 mol) into a reactor. The mixture reacted at room temperature for 6 h to carry out a substitution reaction V. After washing and distillation, the final product (i.e., the anti-fingerprint agent) was obtained. A proton nuclear magnetic resonance (¹H NMR) spectrum of the final product is shown in FIG. 1.

The anti-fingerprint agent prepared in Example 1 was used for substrate coating (plasma treatment for 3 min, voltage of 65-68 V, current of 2.5-3 A; electron gun preheating power of 10%-15%, silicon deposition of 12 nm, turntable rotation of 99.9%, and three-stage evaporation voltage ratio A:B:C of 20.5%:22.1%:22.1%). After completion, the adhesion, initial water contact angle, rubber abrasion resistance, steel wool abrasion resistance, and oil-based pen resistance of the substrate surface were tested, and the test results are shown in Table 1.

### Example 2

An anti-fingerprint agent provided in this example has a structural formula as follows:

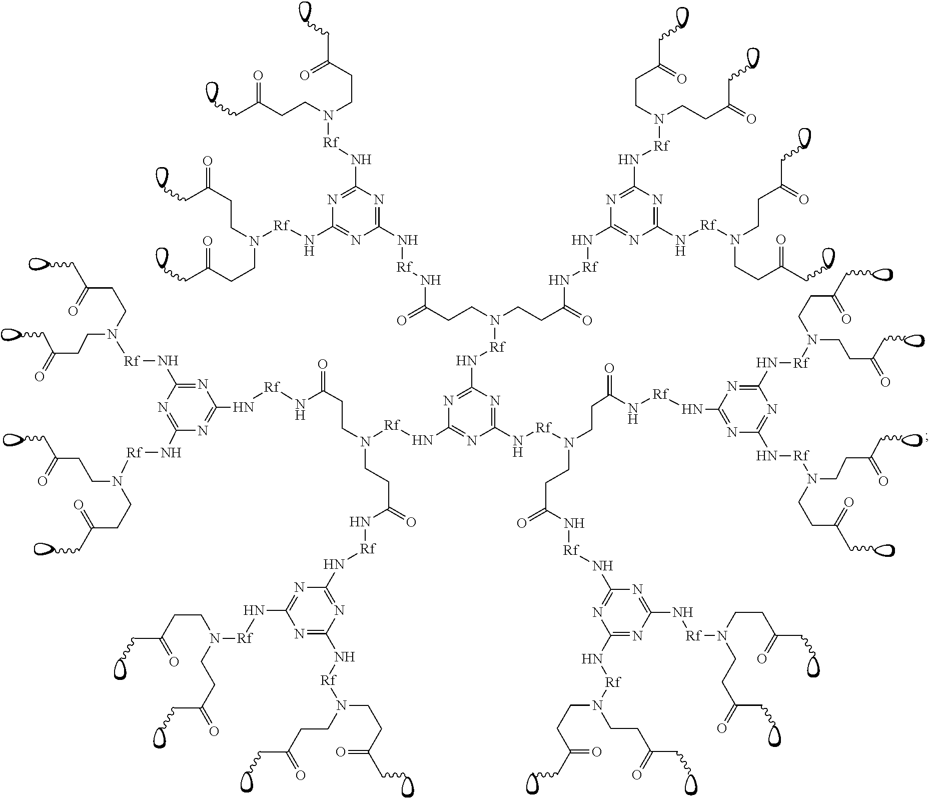

wherein Rf is a main structure of tetrafluorop-phenylenediamine, whose structural formula is shown below:

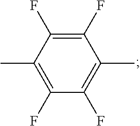

[symbol] is a polymer backbone structure of the tetrafluorop-phenylenediamine, methyl acrylate, and trichlorotriazine, whose structural formula is shown below:

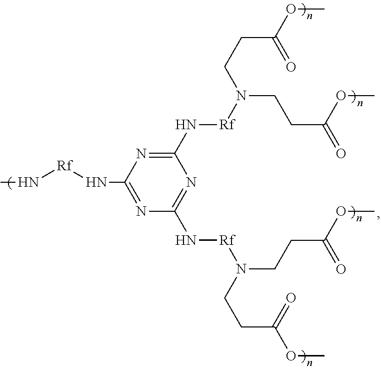

where n=10; and
[symbol] is a product of a substitution reaction between 2-chloroethyltrimethoxysilane and tetrafluorop-phenylenediamine, whose structural formula is shown below:

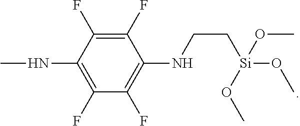

The preparation steps of the anti-fingerprint agent were as follows.
a) 2,4,6-trichloro-1,3,5-triazine (184.4 g, 1 mol) and tetrafluorop-phenylenediamine were weighed at molar ratios of 1:3.5 and 1:2.2, respectively, and added together with acetone (5 mol) and sodium carbonate (2.5 wt % based on the 2,4,6-trichloro-1,3,5-triazine) into two separate reactors. A substitution reaction I and a substitution reaction II were carried out separately in an ice-water bath for 3 h. The products were separated and purified by column chromatography (hexane:ethyl acetate=60:40, v/v), to obtain 2,4,6-tris(fluorinated aromatic diamine)-1,3,5-triazine and 2-chloro-4,6-bis(fluorinated aromatic diamine)-1,3,5-triazine, respectively.
b) The 2,4,6-tris(fluorinated aromatic diamine)-1,3,5-triazine (1 mol) and methyl acrylate were weighed at a molar ratio of 1:7 and added together with acetic acid (5 mol) and copper chloride (2 wt % based on the methyl acrylate) into a reactor. The mixture was refluxed under a nitrogen atmosphere at 120° C. for 6 h to carry out an addition reaction I. After washing and vacuum distillation, the product was purified by silica chromatography column (methanol:ethyl acetate:triethylamine=10:90:5, v/v/v) to obtain intermediate I.
c) The 2-chloro-4,6-bis(fluorinated aromatic diamine)-1,3,5-triazine (1 mol) and methyl acrylate were weighed at a molar ratio of 1:4.3 and added together with acetic acid (5 mol) and copper chloride (2 wt % based on the methyl acrylate) into a reactor. The mixture was refluxed under the nitrogen atmosphere at 120° C. for 6 h to carry out an addition reaction II. After washing and vacuum distillation, the product was purified by the silica chromatography column (petroleum ether:ethyl acetate:triethylamine=50:50:3, v/v/v) to obtain intermediate II.
d) The intermediate II (1 mol) and the tetrafluorop-phenylenediamine were weighed at a molar ratio of 1:1.1 and added together with acetone (5 mol) and sodium carbonate (2.5 wt % based on the tetrafluorop-phenylenediamine) into a reactor. The mixture reacted in the ice-water bath for 4 h to carry out a substitution reaction III. After washing and vacuum distillation, monomer I was obtained.
e) The intermediate I (1 mol) and the monomer I were weighed at a molar ratio of 1:1.1*(6+24n) (n=10) and added together with acetone (5 mol) and sodium hydroxide (0.5 wt % based on the intermediate I) into a reactor. Under refluxing at 120° C. for 10 h, excess monomer I and the intermediate I undergone a polymerization reaction to produce intermediate III, which was a hyperbranched fluorinated polyurethane with a three-dimensional structure.
f) The chloroethyltrimethoxysilane (1 mol) and tetrafluorop-phenylenediamine were weighed at a molar ratio of 1:1.3 and added together with dichloromethane (2 mol) into a reactor. The mixture reacted at room temperature for 2 h to carry out a substitution reaction IV. After washing and distillation, siloxane-containing fluorinated aromatic diamine was obtained.
g) The intermediate III (1 mol) and the siloxane-containing fluorinated aromatic diamine were weighed at a molar ratio of 1:4.6*(6+24n) (n=10) and added together with ferric chloride (3 wt % based on the intermediate III) and dichloromethane (10 mol) into a reactor. The mixture reacted at room temperature for 7 h to carry out a substitution reaction V. After washing and distillation, the final product (i.e., the anti-fingerprint agent) was obtained.

The anti-fingerprint agent was used for substrate coating using the same procedure as that in Example 1. After completion, the adhesion, initial water contact angle, rubber abrasion resistance, steel wool abrasion resistance, and oil-based pen resistance of the substrate surface were tested, and the results are shown in Table 1.

### Example 3

An anti-fingerprint agent provided in this Embodiment has a structural formula as follows:

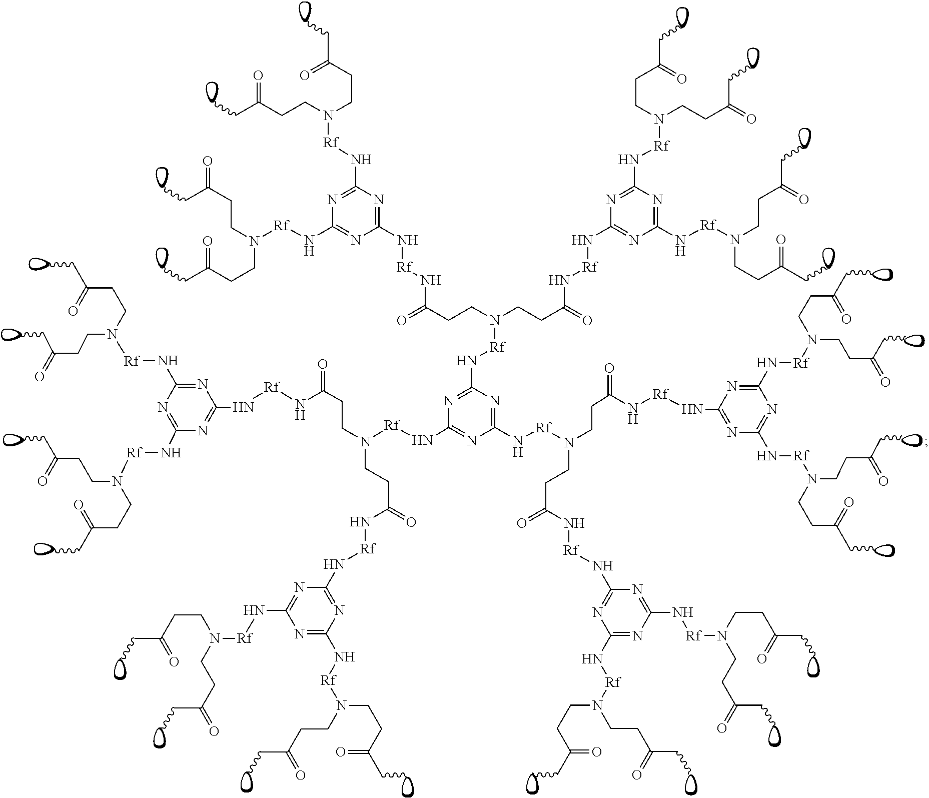

wherein Rf is a main structure of tetrafluoro-1,3-benzenediamine, whose structural formula is shown below:

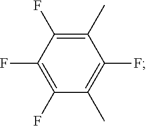

[symbol] is a main polymer structure of tetrafluoro-1,3-benzenediamine, methyl acrylate, and trichlorotriazine, whose structural formula is shown below:

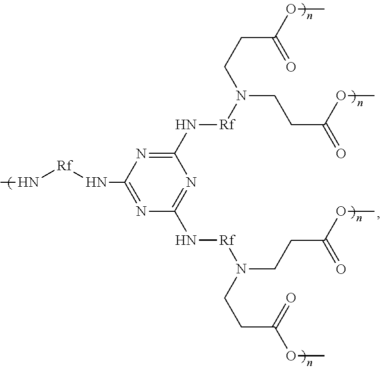

where n=10; and
[symbol] is a product of a substitution reaction between chloromethyltrimethoxysilane and tetrafluoro-1,3-benzenediamine, whose structural formula is shown below:

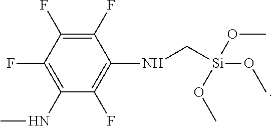

The preparation steps of the anti-fingerprint agent were as follows.
a) 2,4,6-trichloro-1,3,5-triazine (184.4 g, 1 mol) and tetrafluoro-1,3-benzenediamine were weighed at molar ratios of 1:3.6 and 1:2.1, respectively, and added together with acetone (5 mol) and sodium carbonate (3 wt % based on the tetrafluoro-1,3-benzenediamine) into two separate reactors. A substitution reaction I and a substitution reaction II were carried out in an ice-water bath for 2 h, respectively. The products were purified by column chromatography (hexane:ethyl acetate=60:40, v/v) to obtain 2,4,6-tris(fluorinated aromatic diamine)-1,3,5-triazine and 2-chloro-4,6-bis(fluorinated aromatic diamine)-1,3,5-triazine, respectively.
b) The 2,4,6-tris(fluorinated aromatic diamine)-1,3,5-triazine (1 mol) and methyl acrylate were weighed at a molar ratio of 1:6.8 and added together with acetic acid (5 mol) and copper chloride (2.5 wt % based on the methyl acrylate) into a reactor. Under a nitrogen atmosphere, the mixture was refluxed at 120° C. for 8 h to carry out an addition reaction I. After washing and vacuum distillation, the product was purified by the silica chromatography column (methanol:ethyl acetate:triethylamine=10:90:5, v/v/v) to obtain intermediate I.
c) The 2-chloro-4,6-bis(fluorinated aromatic diamine)-1,3,5-triazine (1 mol) and methyl acrylate were weighed at a molar ratio of 1:4.2 and added together with acetic acid (5 mol) and copper chloride (2.5 wt % based on the methyl acrylate) into a reactor. Under the nitrogen atmosphere, the mixture was refluxed at 120° C. for 8 h to carry out an addition reaction II. After washing and vacuum distillation, the product was purified by the silica chromatography column (petroleum ether:ethyl acetate:triethylamine=50:50:3, v/v/v) to obtain intermediate II.
d) The intermediate II (1 mol) and the tetrafluoro-1,3-benzenediamine were weighed at a molar ratio of 1:0.9 and added together with acetone (5 mol) and sodium carbonate (2 wt % based on the tetrafluoro-1,3-benzenediamine) into a reactor. The mixture reacted for 2 h in the ice-water bath to carry out a substitution reaction III. After washing and vacuum distillation, monomer I was obtained.
e) The intermediate I (1 mol) and the monomer I were weighed at a molar ratio of 1:1.2*(6+24n) (n=10) and added together with acetone (5 mol) and sodium hydroxide (0.5 wt % based on the intermediate I) into a reactor. Under refluxing at 110° C. for 10 h, excess monomer I and the intermediate I undergone a polymerization reaction to produce intermediate III, which was a hyperbranched fluorinated polyurethane with a three-dimensional structure.
f) The chloromethyltrimethoxysilane (1 mol) and the tetrafluoro-1,3-benzenediamine were weighed at a molar ratio of 1:1.2 and added together with dichloromethane (2 mol) into a reactor. The mixture reacted at room temperature for 2 h to carry out a substitution reaction IV. After washing and distillation, siloxane-containing fluorinated aromatic diamine was obtained.
g) The intermediate III (1 mol) and the siloxane-containing fluorinated aromatic diamine were weighed at a molar ratio of 1:4.3*(6+24n) (n=10) and added together with ferric chloride (3 wt % based on the intermediate III) and dichloromethane (10 mol) into a reactor. The mixture reacted at room temperature for 7 h to carry out a substitution reaction V. After washing and distillation, the final product (i.e., the anti-fingerprint agent) was obtained.

The anti-fingerprint agent was used for substrate coating using the same procedure as that in Example 1. After completion, the adhesion, initial water contact angle, rubber abrasion resistance, steel wool abrasion resistance, and oil-based pen resistance of the substrate surface were tested, and the results are shown in Table 1.

### Comparative Example 1

This comparative example differs from Example 1 in that the 4,4′-diaminooctafluorobiphenyl is replaced with 4,4′-diaminobiphenyl, while all other preparation steps and conditions remain the same.

The obtained product was used for substrate coating using the same procedure as that in Example 1. After completion, the adhesion, initial water contact angle, rubber abrasion resistance, steel wool abrasion resistance, and oil-based pen resistance of the substrate surface were tested, and the results are shown in Table 1.

### Comparative Example 2

This comparative example differs from Example 1 in that the chloromethyltriethoxysilane is no longer added for end-capping treatment, while all other preparation steps and conditions remain the same.

The obtained product was used for substrate coating using the same procedure as that in Example 1. After completion, the adhesion, initial water contact angle, rubber abrasion resistance, steel wool abrasion resistance, and oil-based pen resistance of the substrate surface (e.g., a tempered film of the mobile phone) were tested, and the results are shown in Table 1.

TABLE 1
Performance test results of products from
different examples and comparative examples

| | | | | | Comparative | Comparative |
|---|---|---|---|---|---|---|
| Test Indicator | | Example 1 | Example 2 | Example 3 | example 1 | example 2 |
| Adhesion | | 5B | 5B | 5B | 5B | 5B |
| Initial water | | 114° | 113° | 111° | 95° | 94° |
| contact angle | | | | | | |
| Rubber | 3000 | 110° | 111° | 108° | 91° | 85° |
| abrasion | cycles | | | | | |
| resistance | 5000 | 108° | 109° | 105° | 88° | 80° |
| | cycles | | | | | |
| Steel | 3000 | 109° | 108° | 105° | 86° | 87° |
| wool | cycles | | | | | |
| abrasion | 5000 | 107° | 104° | 103° | 82° | 64° |
| resistance | cycles | | | | | |

| | | | | | |
|---|---|---|---|---|---|
| Oil-based pen | 49 | 41 | 43 | 18 | 15 |
| resistance | | | | | |

Adhesion: employ a cross-cut test, perform three tests using 3M 600 tape.

The hydrophobic angle (i.e., the water contact angle) test method: the static contact angle of the coating was measured using a JGW-360a contact angle goniometer. The volume of test liquid was 2 μL, and the testing environment was maintained at 24±1° C. with a relative humidity of 45±1%. The water contact angle was measured at five points, and the average value was taken as the water contact angle.

Rubber abrasion resistance test method: the rubber abrasion resistance was measured using a ZJ-339-GSR abrasion tester. The coated substrate was fixed on the tester, with a pressure set to 1000 g, a stroke of 40 mm, and a speed of 40 cycles per minute. After the test, the water contact angle of the substrate was recorded.

Steel wool abrasion resistance test method: the steel wool abrasion resistance was measured using a ZJ-339-GSR abrasion tester. The coated substrate was fixed on the tester, with a rubber model being MUNBANGSAWOO, a pressure set to 1000 g, a stroke of 40 mm, and a speed of 40 cycles per minute. After the test, the water contact angle of the substrate was recorded.

Oil-based marker resistance test: two symmetrical points were marked in the middle of the sample plate, with a distance of 5 cm between the two points. A straight line was drawn between the two points using an oil-based pen, then was wiped with a dust-free cloth, which was recorded as one cycle. The process of drawing a straight line at a same location and wiping it with a dust-free cloth was repeated until the oil-based marker cannot be completely wiped out by the dust-free cloth, which was recorded as N cycles. Then the oil-based pen resistance is N-1 cycles. The more cycles the oil-based pen is used, the better the oil resistance of the surface.

Data from Examples 1-3 shows that the anti-fingerprint agent, when attached to the substrate surface as a coating material, exhibits excellent adhesion strength, hydrophobicity and antifouling properties, abrasion resistance, and oil-based pen resistance. In Comparative examples 1 and 2, due to an absence of the C—F functional groups and the siloxane used for end-capping respectively, although the resulting substrate surfaces do not show significant differences in adhesion, hydrophobicity, abrasion resistance, and oil-based pen resistance decrease noticeably.

FIG. 1 is a ¹H NMR spectrum of the anti-fingerprint agent prepared in Example 1, demonstrating a successful synthesis of the anti-fingerprint agent.

The beneficial effects of the embodiments of the present disclosure are as follows:
1) The anti-fingerprint agent provided by the present disclosure has the hyperbranched three-dimensional structure, which imparts the polyurethane with good tensile resistance and abrasion resistance. In addition, the C—F bonds and the siloxane used for end-capping endow the polyurethane with a strong polarity, high stability, and an excellent thermal resistance. Therefore, the anti-fingerprint agent exhibits outstanding hydrophobicity, antifouling, anti-fingerprint, and abrasion resistance.
2) The anti-fingerprint agent provided by the present disclosure avoids the use of perfluoroalkyl or polyfluoroalkyl substances (PFASs) subject to the restriction proposal of the European Union, thereby achieving low toxicity and degradability, and meeting the requirements for being friendly to both humans and the environment.
3) The method for preparing the anti-fingerprint agent provided by the present disclosure adopts mature substitution reactions and addition reactions to synthesize the anti-fingerprint agent, offering simple operation, a high reaction rate, and mild reaction conditions, thereby facilitating industrial production.
4) After the anti-fingerprint agent provided by the present disclosure is coated by vacuum evaporation, an initial water contact angle on the substrate surface is above 111°, and even after 5,000 cycles of rubbing with a rubber and steel wool, the water contact angle remains at about 105°. The adhesion test result is 5B, indicating excellent anti-fingerprint property and abrasion resistance.

It should be noted that the above embodiments are only used to illustrate the technical solutions of the present disclosure, and are not intended to be a limitation of the technical solutions of the present disclosure. Notwithstanding that the present disclosure has been described in detail with reference to the foregoing embodiments, it should be understood by those skilled in the art that they are still able to make modifications to the technical solutions documented in the foregoing embodiments, or replace some or all of the technical features with equivalent ones; and these modifications or replacements do not take the essence of the corresponding technical solutions out of the scope of the technical solutions of the embodiments of the present disclosure.

What is claimed is:

1. An anti-fingerprint agent having a structural formula as follows: 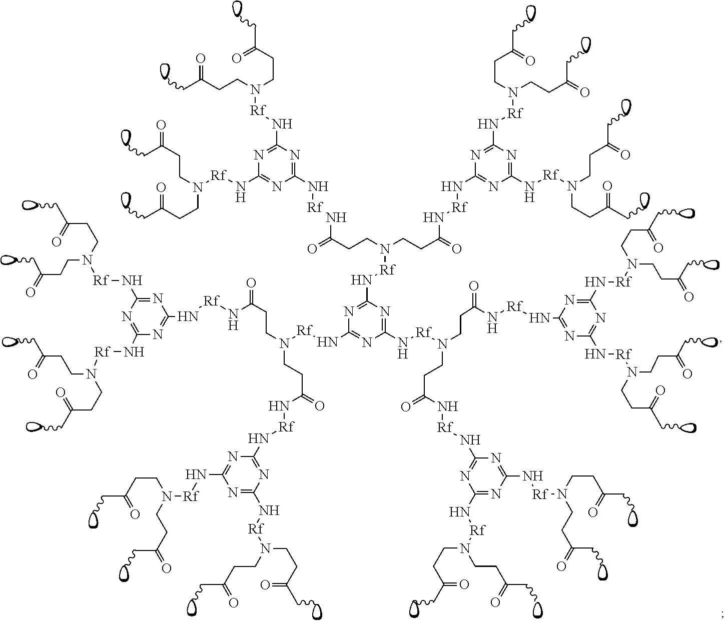
wherein
Rf is a fluoroaromatic moiety, [symbol]
is a structural unit as follows: 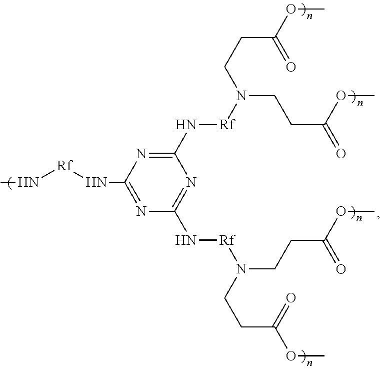
n is an integer between 1 and 3000; and [symbol]
is a fluorosiloxane moiety.

[symbol]

2. The anti-fingerprint agent according to claim 1, wherein
the fluoroaromatic moiety has a structural formula as follows: 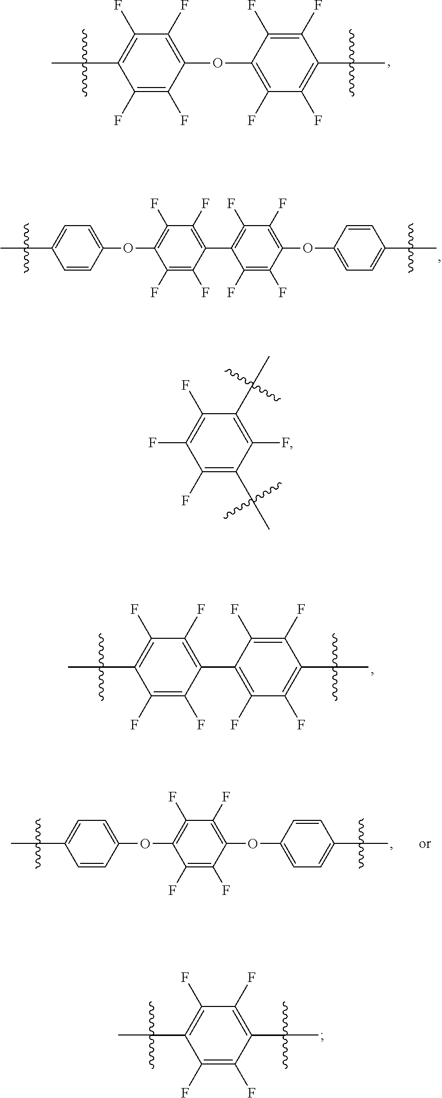 [SMILES: *c1c(F)c(F)c(Oc2c(F)c(F)c(*)c(F)c2F)c(F)c1F ; *c1ccc(Oc2c(F)c(F)c(-c3c(F)c(F)c(Oc4ccc(*)cc4)c(F)c3F)c(F)c2F)cc1 ; *c1c(F)c(*)c(F)c(F)c1F ; *c1c(F)c(F)c(-c2c(F)c(F)c(*)c(F)c2F)c(F)c1F ; *c1ccc(Oc2c(F)c(F)c(Oc3ccc(*)cc3)c(F)c2F)cc1 ; *c1c(F)c(F)c(*)c(F)c1F]
and
the fluorosiloxane moiety has a structural formula as follows:

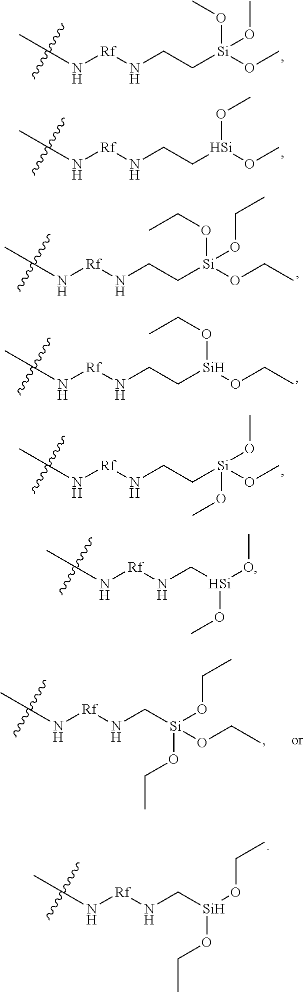

3. A method for preparing the anti-fingerprint agent of claim 1, comprising:
a) 2,4,6-trichloro-1,3,5-triazine and fluorinated aromatic diamine undergoing a substitution reaction I to obtain 2,4,6-tris(fluorinated aromatic diamine)-1,3,5-triazine; and
2,4,6-trichloro-1,3,5-triazine and fluorinated aromatic diamine undergoing a substitution reaction II to obtain 2-chloro-4,6-bis(fluorinated aromatic diamine)-1,3,5-triazine;
wherein the 2,4,6-tris(fluorinated aromatic diamine)-1,3,5-triazine has a structural formula as follows: 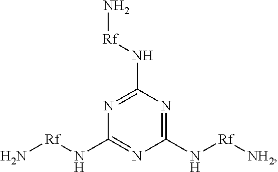
and
the 2-chloro-4,6-bis(fluorinated aromatic diamine)-1,3,5-triazine has a structural formula as follows: 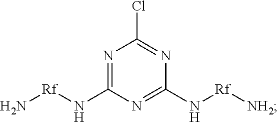
b) the 2,4,6-tris(fluorinated aromatic diamine)-1,3,5-triazine and methyl acrylate undergoing an addition reaction I to obtain intermediate I;
wherein the intermediate I has a structural formula as follows: 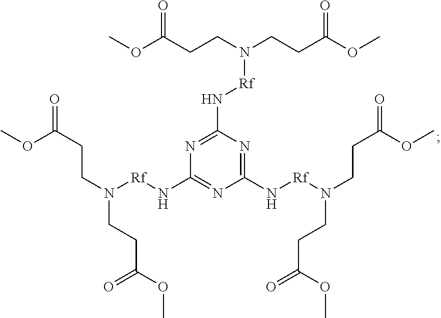
c) the 2-chloro-4,6-bis(fluorinated aromatic diamine)-1,3,5-triazine and methyl acrylate undergoing an addition reaction II to obtain intermediate II;
wherein the intermediate II has a structural formula as follows: 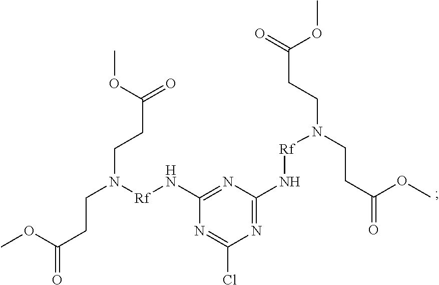
d) the intermediate II and fluorinated aromatic diamine undergoing a substitution reaction III to obtain monomer I;
wherein the monomer I has a structural formula as follows: 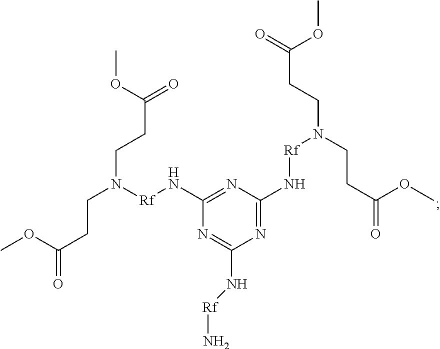
e) the intermediate I and the monomer I undergoing a polymerization reaction to obtain a hyperbranched fluorinated polyurethane;
wherein the hyperbranched fluorinated polyurethane has a structural formula as follows: 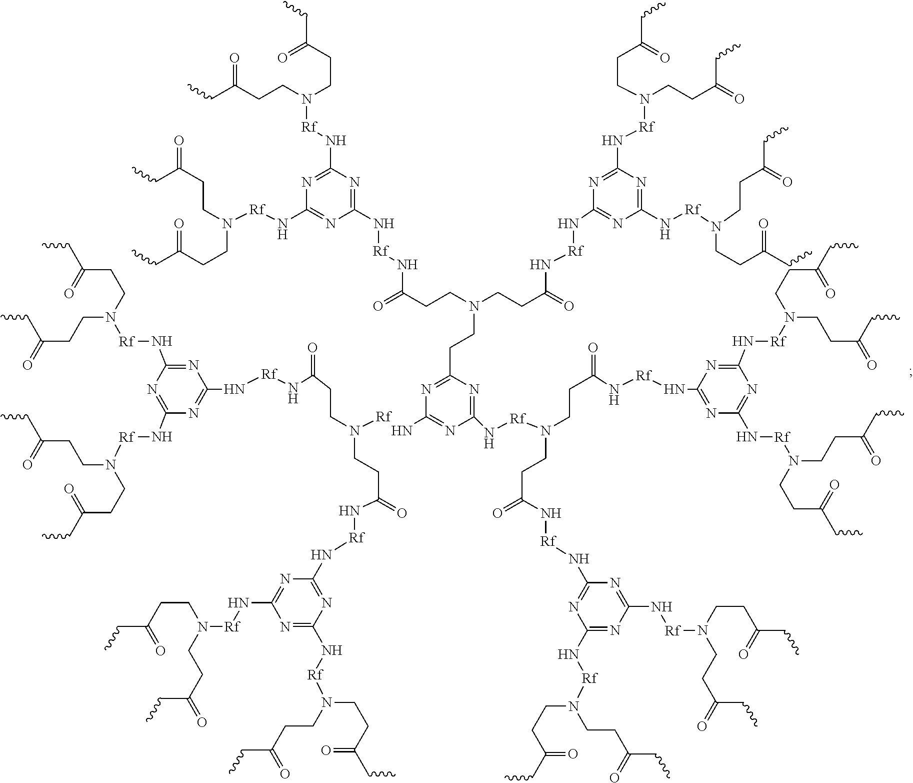
f) chloroalkyl siloxane and fluorinated aromatic diamine undergoing a substitution reaction IV to obtain siloxane-containing fluorinated aromatic diamine;
wherein the siloxane-containing fluorinated aromatic diamine has a structural formula as follows: 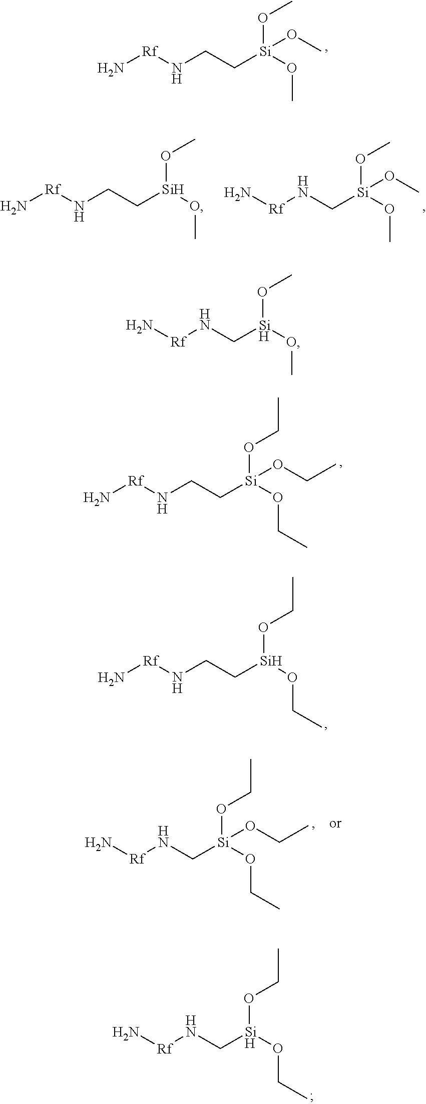
and
g) the hyperbranched fluorinated polyurethane and the siloxane-containing fluorinated aromatic diamine undergoing a substitution reaction V to obtain the anti-fingerprint agent.

4. The method according to claim 3, wherein the fluorinated aromatic diamine includes at least one of

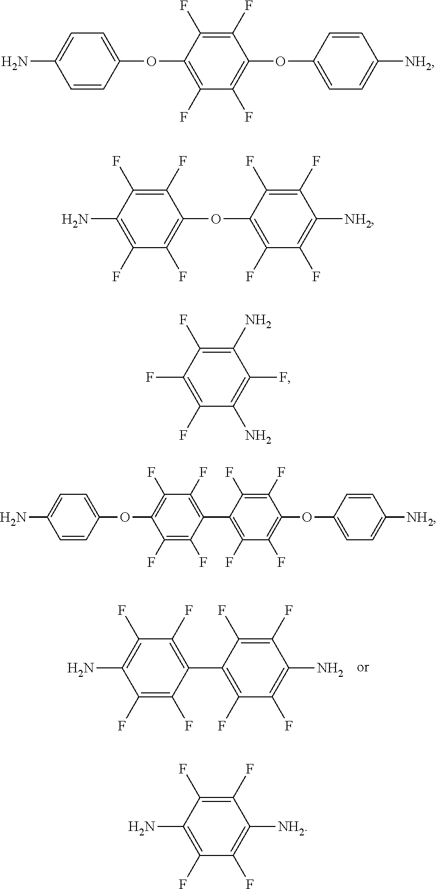

5. The method according to claim 3, wherein the chloroalkyl siloxane includes at least one of

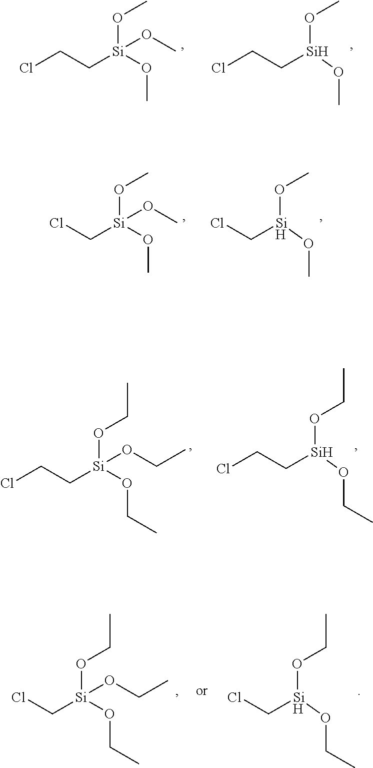

6. The method according to claim 3, wherein
a reaction condition of the substitution reaction I, the substitution reaction II, and the substitution reaction III is reacting for 2-6 h in an ice-water bath in the presence of a base;
a reaction condition of the substitution reaction IV is reacting for 2-4 h at room temperature; and
a reaction condition of the substitution reaction V is reacting for 4-8 h at room temperature under a catalytic action of ferric chloride;
wherein
a molar ratio of the 2,4,6-trichloro-1,3,5-triazine to the fluorinated aromatic diamine in the substitution reaction I is 1:(3-3.8);
a molar ratio of the 2,4,6-trichloro-1,3,5-triazine to the fluorinated aromatic diamine in the substitution reaction II is 1:(1.8-2.4);
a molar ratio of the intermediate II to the fluorinated aromatic diamine in the substitution reaction III is 1:(0.7-1.2);
a molar ratio of the chloroalkyl siloxane to the fluorinated aromatic diamine in the substitution reaction IV is 1:(1-1.6); and
a molar ratio of the hyperbranched fluorinated polyurethane to the siloxane-containing fluorinated aromatic diamine in the substitution reaction V is 1:(4-5)*(6+24n), n being an integer between 0 and 3000.

7. The method according to claim 3, wherein
a reaction condition of the addition reaction I and the addition reaction II is refluxing for 4-10 h at 80-120° C. under a catalytic action of copper chloride;
wherein
a molar ratio of the 2,4,6-tris(fluorinated aromatic diamine)-1,3,5-triazine to the methyl acrylate in the addition reaction I is 1:(6-8); and
a molar ratio of the 2-chloro-4,6-bis(fluorinated aromatic diamine)-1,3,5-triazine to the methyl acrylate in the addition reaction II is 1:(4-5).

8. The method according to claim 3, wherein
a reaction condition of the polymerization reaction is refluxing for 8-12 h at 80-120° C. in the presence of a base;
wherein a molar ratio of the intermediate I to the monomer I in the polymerization reaction is 1:(1-1.2)*(6+24n), n being an integer between 0 and 3000.

9. A method for preparing the anti-fingerprint agent of claim 2, comprising:
a) 2,4,6-trichloro-1,3,5-triazine and fluorinated aromatic diamine undergoing a substitution reaction I to obtain 2,4,6-tris(fluorinated aromatic diamine)-1,3,5-triazine; and
2,4,6-trichloro-1,3,5-triazine and fluorinated aromatic diamine undergoing a substitution reaction II to obtain 2-chloro-4,6-bis(fluorinated aromatic diamine)-1,3,5-triazine;
wherein the 2,4,6-tris(fluorinated aromatic diamine)-1,3,5-triazine has a structural formula as follows: 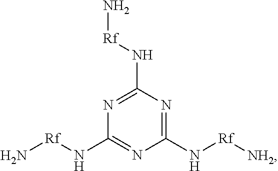
and
the 2-chloro-4,6-bis(fluorinated aromatic diamine)-1,3,5-triazine has a structural formula as follows: 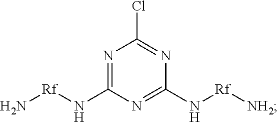
b) the 2,4,6-tris(fluorinated aromatic diamine)-1,3,5-triazine and methyl acrylate undergoing an addition reaction I to obtain intermediate I;
wherein the intermediate I has a structural formula as follows: 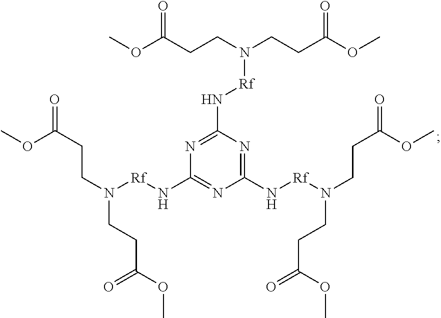
c) the 2-chloro-4,6-bis(fluorinated aromatic diamine)-1,3,5-triazine and methyl acrylate undergoing an addition reaction II to obtain intermediate II;
wherein the intermediate II has a structural formula as follows: 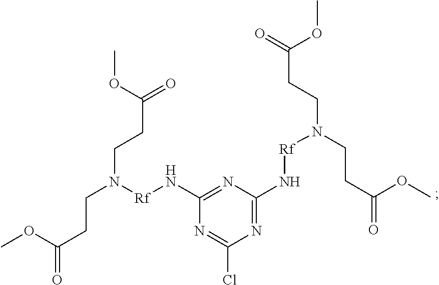
d) the intermediate II and fluorinated aromatic diamine undergoing a substitution reaction III to obtain monomer I;
wherein the monomer I has a structural formula as follows: 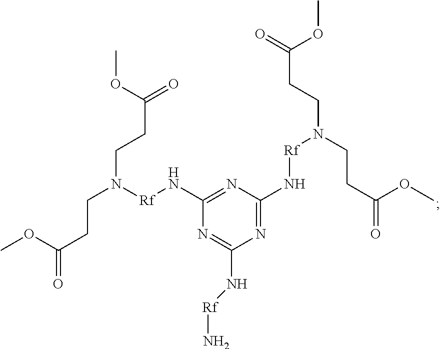
e) the intermediate I and the monomer I undergoing a polymerization reaction to obtain a hyperbranched fluorinated polyurethane;
wherein the hyperbranched fluorinated polyurethane has a structural formula as follows: 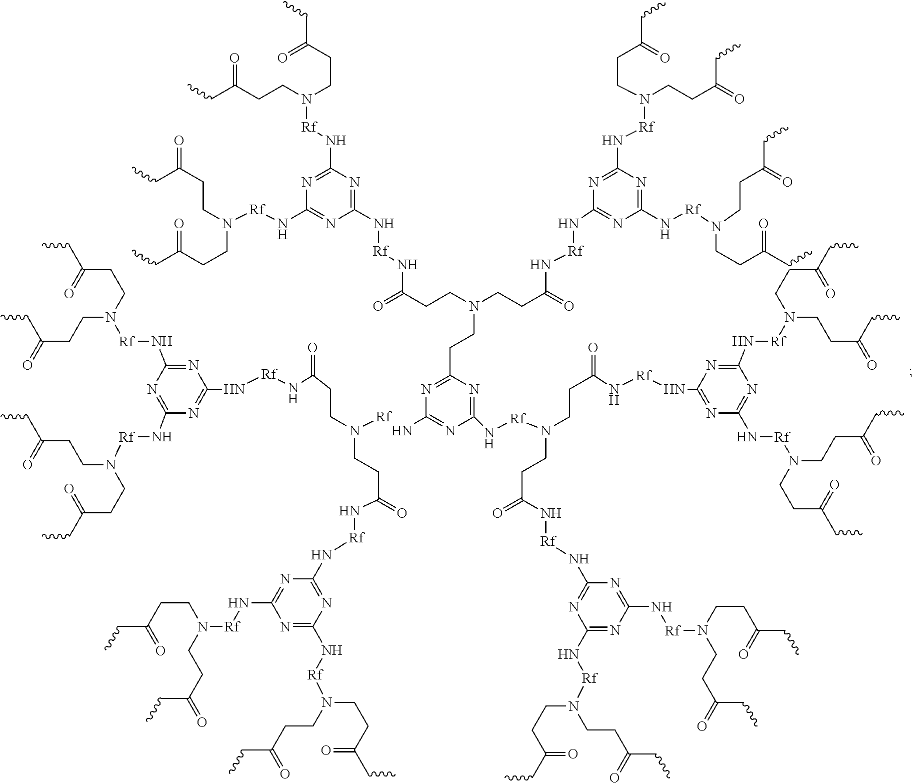
f) chloroalkyl siloxane and fluorinated aromatic diamine undergoing a substitution reaction IV to obtain siloxane-containing fluorinated aromatic diamine;
wherein the siloxane-containing fluorinated aromatic diamine has a structural formula as follows: 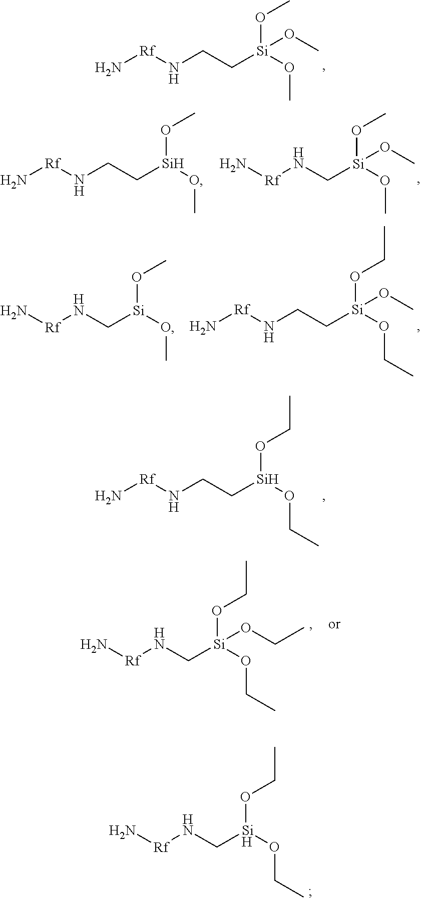
and
g) the hyperbranched fluorinated polyurethane and the siloxane-containing fluorinated aromatic diamine undergoing a substitution reaction V to obtain the anti-fingerprint agent.

10. The method according to claim 9, wherein the fluorinated aromatic diamine includes at least one of

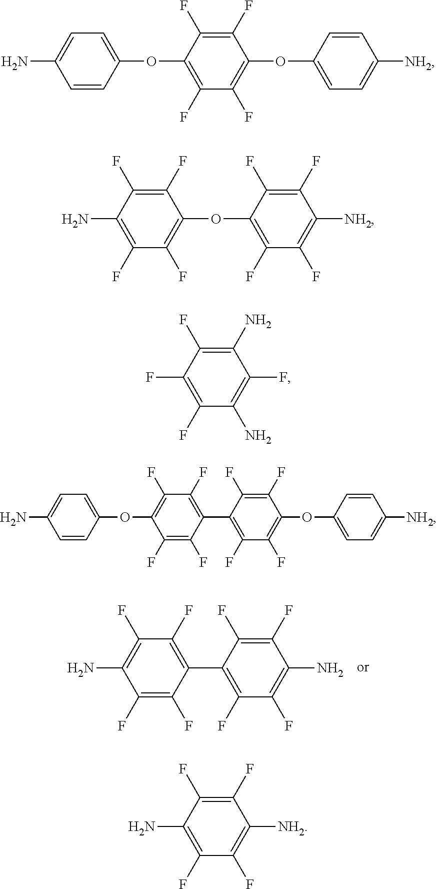

11. The method according to claim 9, wherein the chloroalkyl siloxane includes at least one of:

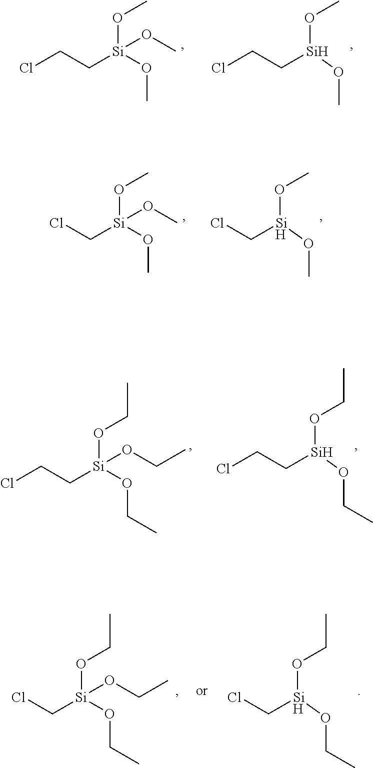

12. The method according to claim 9, wherein
a reaction condition of the substitution reaction I, the substitution reaction II, and the substitution reaction III is reacting for 2-6 h in an ice-water bath in the presence of a base;
a reaction condition of the substitution reaction IV is reacting for 2-4 h at room temperature; and
a reaction condition of the substitution reaction V is reacting for 4-8 h at room temperature under a catalytic action of ferric chloride;
wherein
a molar ratio of the 2,4,6-trichloro-1,3,5-triazine to the fluorinated aromatic diamine in the substitution reaction I is 1:(3-3.8);
a molar ratio of the 2,4,6-trichloro-1,3,5-triazine to the fluorinated aromatic diamine in the substitution reaction II is 1:(1.8-2.4);
a molar ratio of the intermediate II to the fluorinated aromatic diamine in the substitution reaction III is 1:(0.7-1.2);
a molar ratio of the chloroalkyl siloxane to the fluorinated aromatic diamine in the substitution reaction IV is 1:(1-1.6); and
a molar ratio of the hyperbranched fluorinated polyurethane to the siloxane-containing fluorinated aromatic diamine in the substitution reaction V is 1:(4-5)*(6+24n), n being an integer between 0 and 3000.

13. The method according to claim 9, wherein
a reaction condition of the addition reaction I and the addition reaction II is refluxing for 4-10 h at 80-120° C. under a catalytic action of copper chloride;
wherein
a molar ratio of the 2,4,6-tris(fluorinated aromatic diamine)-1,3,5-triazine to the methyl acrylate in the addition reaction I is 1:(6-8); and
a molar ratio of the 2-chloro-4,6-bis(fluorinated aromatic diamine)-1,3,5-triazine to the methyl acrylate in the addition reaction II is 1:(4-5).

14. The method according to claim 9, wherein
a reaction condition of the polymerization reaction is refluxing for 8-12 h at 80-120° C. in the presence of a base;
wherein a molar ratio of the intermediate I to the monomer I in the polymerization reaction is 1:(1-1.2)*(6+24n), n being an integer between 0 and 3000.
